(19) United States
(12) Patent Application Publication
(10) Pub. No.: US 2025/0179778 A1
(43) Pub. Date: Jun. 5, 2025

(54) Systems and Methods for Generating Water From Air

(71) Applicant: Source Global, PBC, Scottsdale, AZ (US)

(72) Inventors: Cody Friesen, Scottsdale, AZ (US); Michael Robinson, Scottsdale, AZ (US); Justin Gillum, Scottsdale, AZ (US); Eric Leahy, Scottsdale, AZ (US); Hooman Mobarakeh, Scottsdale, AZ (US); Kamil Salloum, Scottsdale, AZ (US); Joshua Peterson, Scottsdale, AZ (US)

(21) Appl. No.: 18/961,120

(22) Filed: Nov. 26, 2024

Related U.S. Application Data
(60) Provisional application No. 63/604,635, filed on Nov. 30, 2023.

(51) Int. Cl. E03B 3/28; B01D 5/00

(52) U.S. Cl. CPC E03B 3/28; B01D 5/0054

(57) ABSTRACT

Systems and methods for heat exchange and water generation are disclosed. Water generation systems described herein include a housing with a front surface comprising a solar thermal portion to convert solar radiation into heat and a solar electric portion to convert solar radiation into electrical energy. A sorption unit or layer captures water vapor from a process gas during a sorption mode and releases water vapor to a regeneration fluid heated by the solar thermal portion during a desorption mode. A heat exchange assembly includes a condenser to condense water from the regeneration fluid and a recuperator to transfer heat between fluid flow segments. Methods include directing a regeneration fluid along a flow path through a solar thermal portion, capturing and releasing water vapor via a sorption unit or layer, transferring heat using a recuperator, directing cooling fluid through a condenser, and condensing water vapor from the regeneration fluid.

### CROSS-REFERENCE TO RELATED APPLICATION

This application claims priority to U.S. Provisional Application Ser. No. 63/604,635, filed on Nov. 30, 2023, the disclosure of which is incorporated by reference in its entirety.

### TECHNICAL FIELD

This disclosure is related to systems and methods for generating liquid water from ambient air. This disclosure is also related to systems and methods for recuperative heat exchange.

### BACKGROUND

Producing liquid water by extracting water vapor from ambient air or atmospheric air can present various challenges. Certain challenges include those associated with maximizing a water production rate and/or efficiency at a low cost and high reliability. There exists a need for improved systems and methods for producing liquid water from atmospheric air and in some cases, by compact or modular devices that are configured for high efficiency, reliability for extended field lifetime, simple manufacture and low cost.

Heat exchanger assemblies and more specifically recuperative heat exchange assemblies to transfer heat between fluid streams can improve energy efficiency in various applications. However, existing heat exchange assemblies often face limitations in efficiency, thermal transfer capacity, or size, making them less suitable for compact or high-performance systems. Accordingly, there exists a need for improved heat exchange assemblies that offer enhanced thermal efficiency, reduced size, and greater adaptability for integration into advanced systems, such as water generation technologies.

### BRIEF SUMMARY

Systems and methods for heat exchange and water generation are described herein. Water generation systems of the present disclosure can include a housing with a front surface for collecting solar radiation with a solar thermal portion configured to convert solar radiation into heat and a solar electric portion configured to convert solar radiation into electrical energy. A sorption body or layer comprising a hygroscopic material can capture water vapor from a process gas, such as ambient air, during a sorption mode and release water vapor to a regeneration fluid heated by the solar thermal portion during a desorption mode. A heat exchange assembly can include a condenser or condenser portion configured to condense water from the regeneration fluid and a recuperator or recuperator portion having a plurality of longitudinally extending heat exchange plates to transfer heat between fluid flow segments.

Heat exchange assemblies including a condenser to condense water from a fluid, such as a regeneration fluid flowing in a closed loop, are also disclosed herein. Heat exchange assemblies of the present disclosure also include a recuperator having a plurality of longitudinally extending heat exchange plates defining alternating flow paths or layers to transfer heat from fluid flow segments.

Furthermore, methods for heat exchange and generating water are also provided. The method can include directing a regeneration fluid along a regeneration flow path, which can include a solar thermal portion for heating the regeneration fluid and a sorption layer containing hygroscopic material to capture water vapor from a process gas during a sorption mode and release water vapor during a desorption mode. Methods described herein can further include transferring heat between a plurality of longitudinally extending heat exchange plates of a recuperator, directing a cooling fluid through a cooling flow path of a condenser, and condensing water vapor from the regeneration fluid via the condenser.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Views in the figures are drawn to scale (unless otherwise noted), meaning the sizes of the depicted elements are accurate relative to each other for at least the embodiment in the view.

FIG. 1 depicts a block diagram of a water generation system;

FIG. 2A depicts a front perspective view of a water generation system installed at an angle on a horizontal mounting surface;

FIG. 2B depicts a rear perspective view of a water generation system installed at an angle on a horizontal mounting surface;

FIG. 2C depicts a side view of a water generation system installed at an angle on a horizontal mounting surface;

FIG. 3A depicts a series process flow path in a water generation system during a sorption cycle;

FIG. 3B depicts a parallel process flow path in a water generation system during a sorption cycle;

FIG. 4A depicts a series regeneration flow path in a water generation system during a desorption cycle;

FIG. 4B depicts a parallel regeneration flow path in a water generation system during a desorption cycle;

FIG. 4C depicts a regeneration flow path in a water generation system comprising a top photovoltaic (PV) layer during a desorption cycle;

FIG. 5A depicts a series process flow path in a water generation system during a sorption cycle;

FIG. 5B depicts a series regeneration flow path in a water generation system during a desorption cycle;

FIG. 6A depicts a heat exchange assembly of a water generation system;

FIG. 6B depicts a heat exchange assembly including mechanical interlocking features;

FIG. 6C depicts a psychrometric chart including operation or process path lines for a fluid flowing in a heat exchange assembly;

FIG. 7A depicts an exploded view of a recuperator including longitudinally extending heat exchange plates;

FIG. 7B depicts an exploded view of a recuperator including longitudinally extending heat exchange plates;

FIG. 7C depicts a top-down view of a heat exchange assembly including a regeneration fluid flow therethrough;

FIG. 7D depicts a top-down view of a heat exchange assembly including a cooling fluid flow therethrough;

FIG. 7E depicts a top-down view a heat exchange assembly including a regeneration fluid flow therethrough;

FIG. 7F depicts a top-down view a heat exchange assembly including a cooling fluid flow therethrough;

FIG. 8A depicts a top-down view a heat exchange assembly including a recuperator having a counter-flow configuration;

FIG. 8B depicts a top-down view a heat exchange assembly including a recuperator having a parallel flow configuration;

FIG. 8C depicts a top-down view a heat exchange assembly including a recuperator having a hybrid flow configuration;

FIG. 9A depicts a side perspective view of a heat exchange assembly including a plurality of heat exchange layers;

FIG. 9B depicts a side perspective view of a heat exchange assembly including a plurality of mechanically interlocking heat exchange layers;

FIG. 10A depicts a side view of a recuperator assembly including heat exchange layers formed in a single extrusion process;

FIG. 10B depicts a side view of a recuperator assembly including heat exchange layers having insert dividers;

FIG. 10C depicts a side view of a recuperator assembly including heat exchange layers having insert dividers and wiper seal elements;

FIG. 10D depicts a side view of a recuperator assembly including heat exchange layers having a high surface area wall geometry;

FIG. 11A depicts a side view of heat exchange layers having parallel fused ladder features;

FIG. 11B depicts a side view of heat exchange layers having open parallel channels;

FIG. 11C depicts a side view of heat exchange layers having perpendicular fused ladder sections;

FIG. 12A depicts a side perspective view of a recuperator including a plurality of extruded heat exchange layers;

FIG. 12B depicts a side view of a recuperator including a plurality of extruded heat exchange layers;

FIG. 12C depicts a side view of a seal assembly of an extruded heat exchange layer of a recuperator;

FIG. 13A depicts a perspective view of a dynamic seal assembly of a sorption unit;

FIG. 13B depicts a side view of a dynamic seal assembly of a sorption unit in a first state;

FIG. 13C depicts a side view of a dynamic seal assembly of a sorption unit in a second state;

FIG. 14 depicts a method of operating a water generation system.

For simplicity and clarity of illustration, the drawing figures show the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

### DESCRIPTION OF ILLUSTRATIVE EMBODIMENTS

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure.

Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Surface shading lines may be used throughout the figures to denote different parts but not necessarily to denote the same or different materials.

This disclosure includes embodiments of systems and methods, such as, for example, for water treatment and storage. The term “coupled” is defined as connected, although not necessarily directly, and not necessarily mechanically. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” “partially” and “about” may be substituted with “within [a percentage] of” what is specified, where the percentage includes 0.1, 1, 5, 10 and 20%. Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements Likewise, a method that “comprises,” “has,” “includes,” or “contains” one or more operations or steps possesses those one or more operations or steps, but is not limited to possessing only those one or more operations or steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. The feature or features of one embodiment may be applied to other embodiments or implementations, even though not described or illustrated, unless expressly prohibited by this disclosure or the nature of the embodiments.

As will be described in detail below, this disclosure describes various systems and methods for efficient water production from a process gas like ambient air. The water generation systems and methods of the present technology combine high water generation efficiency with high lifetime and minimal maintenance in a highly deployable form factor. The present technology offers water generation systems that not only efficiently harness solar energy but also minimizes operational disruptions, contributing to long-term sustainability and reliability.

Water generation systems of the present technology can be characterized by a juxtaposition of 1) solar thermal generation and 2) solar electric generation in a compact configuration (e.g., offset, side-by-side), which can be particularly advantageous to maximize the water production efficiency, water production amount and/or water production rate of the system (e.g., via the ratio or relative areas for solar thermal collection and solar electric collection and/or the relative surface areas for water sorption and heat exchange to drive water condensation upon desorption).

A compact, lightweight and/or slim water generation panel of the present technology can include a sorption unit or layer comprising hygroscopic material(s) disposed beneath a solar thermal unit or portion and a heat exchange assembly disposed beneath a solar electric unit or portion. In the field of water harvesting from ambient humidity, there exists a need to balance thermal energy considerations and power needs for both efficient and compact systems with maximized water production (e.g., amount of water produced over a diurnal cycle), particularly in the autonomous or self-powered (e.g., off-grid) application.

The system configurations and related operational methods of the present technology have been found to harness solar irradiance effectively for water generation. The solar thermal and solar electric collectors, in combination with hygroscopic materials and heat exchange assembly, exhibit unique characteristics and efficiencies in response to wide ranging environmental conditions on earth. In addition to efficiently generating and distributing thermal and electric energy to hygroscopic material and heat exchange subsystems, the disclosed systems facilitate deployment with no or minimal maintenance. The present technology presents an advancement in utilization of collected solar energy, aligning with the necessity to balance thermal energy and electrical power requirements. The disclosed systems and methods maximize thermal efficiency while concurrently meeting the power demands via an interplay between the solar thermal and solar electric collectors in coordination with the sorption and heat exchange units.

Achieving a delicate equilibrium between the thermal and electric power generation functions is imperative for sustained and efficient operation of autonomous and deployable water generation systems. An inherent challenge lies in the dynamic nature of solar irradiance, ambient humidity and ambient temperature and a need to adaptively modulate the system's response to fluctuations in environmental conditions. The disclosed systems and methods represent a significant advancement in addressing the balance between thermal and electrical energy needs for water generation systems comprising hygroscopic materials.

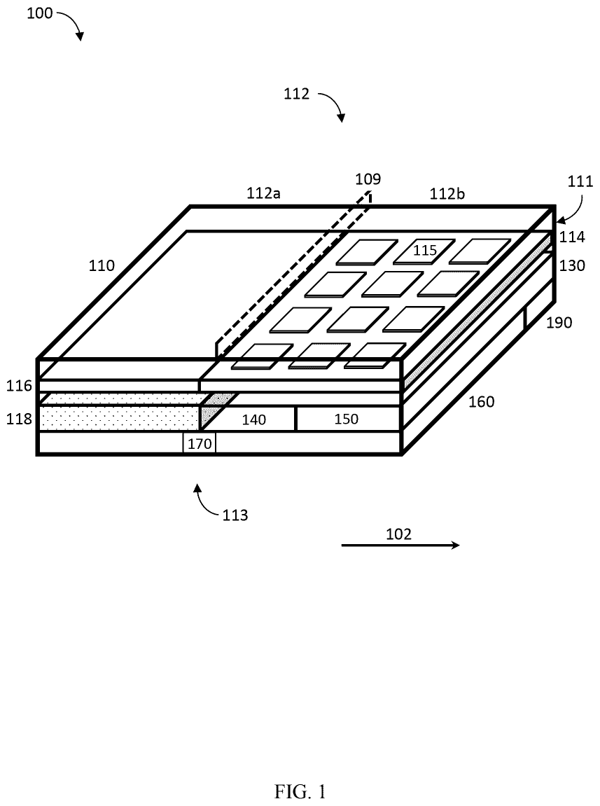

FIG. 1 depicts a water generation system 100 for generating liquid water from a process gas such as ambient air containing water vapor. System 100 comprises a hygroscopic material that can be present in one or more sorption units, bodies or layers 118 to capture water vapor from the process gas during a water uptake, loading or sorption operational mode of the system (e.g., during nighttime, periods of high ambient relative humidity, periods of energy surplus and/or periods of low ambient temperature).

System 100 comprises a housing 110 having a front surface 112 to face the sun and a rear surface 113 opposite the front surface. System 100 further comprises a plurality of sidewalls of housing 111 extending downward from the periphery of the front surface 112 to the rear surface 113 to form a unitary or uniform planar structure characterized by or having a substantially planar design. The water generation system 100 comprises a uniform planar configuration extending along a longitudinal axis 102 to form a space-efficient assembly that minimizes structural complexity while maintaining high water production rates.

During a regeneration, release or desorption operational mode, solar radiation impinging upon the front surface of the system can be converted into both solar thermal energy (e.g., directly and/or indirectly heat the hygroscopic material) and solar electric energy (e.g., via photovoltaic conversion).

The front surface, top layer or cover 112 (e.g., glazing layer comprising one or more layers of transparent material such as glass, transparent polymer(s), polycarbonate sheets or layers, twinwall) can be exposed to the ambient environment to collect solar radiation. The system can comprise a solar thermal unit, layer or portion 112a (e.g., top transparent layer above an interstitial layer 116 of a transparent material such as glass) adjacent to a solar electric layer or 112b (e.g., top transparent layer above an a photovoltaic (PV) layer or PV panel 114 comprising PV cells 115) at the upper portion of the system and exposed to collect solar radiation for conversion to both heat and electricity. The solar electric unit or portion can comprise a PV panel (e.g., 114) comprising a plurality of photovoltaic cells (e.g., 115), that can in some cases be encapsulated between a top transparent layer (e.g., glass) and/or a backsheet material that can reflect solar radiation back towards PV cells 115 and/or transmit solar energy down to another solar collection surface. The system can further comprise a sorption unit or layer (e.g., 118) below the solar thermal portion (e.g., to allow solar radiation to impinge upon sorption unit or layer 118) and adjacent to a heat exchange assembly (e.g., 130) provided below the solar electric portion. In some embodiments, water generation system 100 can comprise at least one interstitial layer (e.g., 116) below the top layer to improve solar radiation collection and/or facilitate heating of a regeneration fluid.

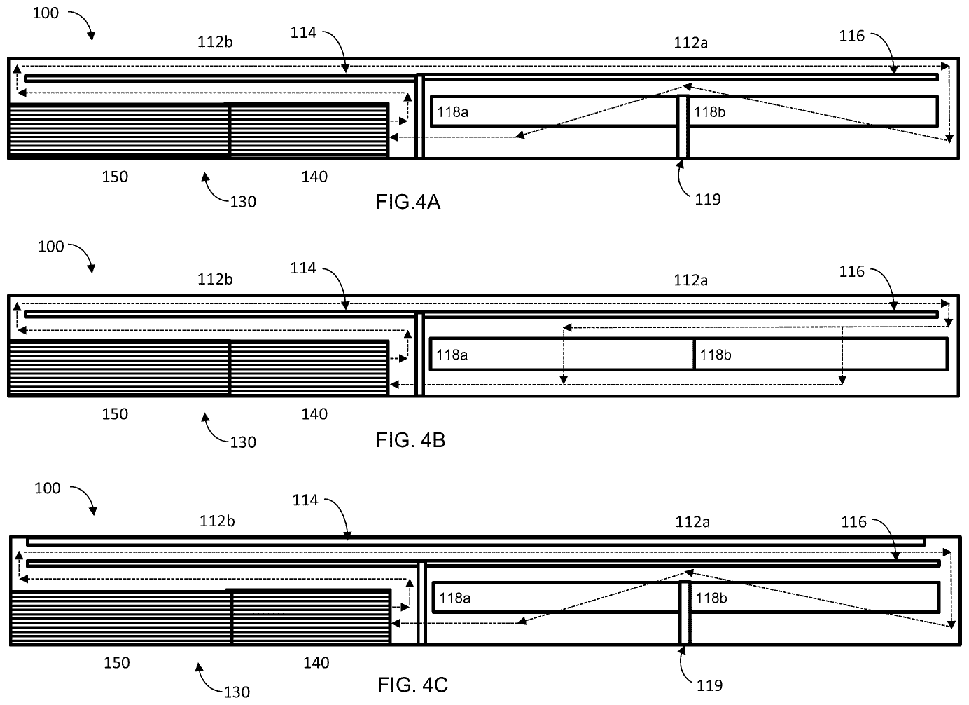

In some implementations such as depicted in FIG. 4A-B, it can be preferable to direct the regeneration fluid output from the condenser (e.g., 150) across a surface of the PV layer (e.g., 114) in advance of flow across a surface of a solar thermal layer such as a transparent interstitial layer (e.g., 116) so as to minimize the regeneration flow path and transitions or turns therein and/or direct cooler fluid across the PV panel in advance of collecting heat from a solar thermal layer. However, in other implementations it can be preferable to direct the regeneration fluid first across a surface of the interstitial layer (e.g., 116) in advance of flow across a surface of the PV layer (e.g., 114).

Water generation systems of the present technology can convert solar insolation to thermal energy by transferring energy from sunlight to a regeneration fluid or gas, a heat absorbing fluid or gas, or a “working” fluid or gas that flows through the water generation system, for example in a regeneration flow path. In some embodiments, the water generation system converts solar insolation to both thermal and electrical energy, for example via one or more glazing layer(s) and photovoltaic layer(s).

The upper or top cover layer 112 can comprise an outer surface exposed to ambient air and an inner surface opposite from the outer surface. The upper or top cover layer can include a glazing and/or a transparent material (e.g., glass) allowing solar radiation to pass into the interior of the water generation system 100. Furthermore, the construction of system 100 (e.g., housing 111 and top cover layer 112) can hermetically seal the internal fluid (e.g., regeneration fluid or internal closed loop airflow during a desorption cycle) from the ambient environment. As depicted in FIG. 1, a first side provided as a solar thermal portion 112a allows solar radiation to impinge upon and heat sorption layer 118 (e.g., via a transparent top cover layer). A second side provided as a solar electric portion 112b comprises one or more photovoltaic (PV) layers, units or panels 114 including PV cells 115 for converting solar insolation to electrical energy. The system can comprise additional layers comprising PV panels for converting solar radiation into electrical energy, interstitial layers and/or glazing layers for converting solar radiation into thermal energy (e.g., transparent layers, glass layers).

The water generation system can be provided as a solar thermal collector to convert radiant solar energy into thermal energy, and in turn, heat the hygroscopic material and/or regeneration fluid. Furthermore, water generation systems of the present technology can be provided as a hybrid solar collector, or photovoltaic thermal solar collector that converts solar radiation into both thermal and electrical energy such that the generated heat is transferred to the hygroscopic material and/or regeneration fluid and the generated electricity powers the components of the water generations system (e.g., fan(s), compressor(s), controller(s) and/or the like). Water generation systems can comprise side-by-side or adjacent front surface portions provided for solar thermal performance (e.g., 112a) and solar electric performance (e.g., 112b).

System 100 comprises a sorption unit or layer 118 (that in some cases can be provided as a plurality of sorption bodies 118a and 118b) located within the housing 110 and below first side including solar thermal portion 112a having a transparent cover layer (e.g., glass). Sorption layer 118 comprises a hygroscopic material to capture water vapor from a process gas during a sorption mode, and release water vapor to a regeneration fluid during a desorption mode.

Water generation system 100 further comprises a hygroscopic material included in a sorption unit, body or layer 118. The sorption unit, layer or body 118 can comprise a light or photonic absorbing material to absorb solar radiation, for example during daytime hours. In an embodiment, the sorption layer 118 comprises or is formed of a hygroscopic material to capture (e.g., adsorb, absorb) water vapor from a process gas (e.g., ambient air at atmospheric temperature and pressure) upon flow across and/or therethrough, for example during a sorption operational cycle (e.g., nighttime hours). Furthermore, the sorption layer 118 can transfer water vapor heat and/or heat to a regeneration or working gas during a desorption operational cycle.

The sorption unit(s) or layer(s) (e.g., 118) can have various compositions and structures. In an example, the sorption layer can be provided as one or more porous hygroscopic bodies or layers. The ‘porous’ or ‘porosity’ term used herein can describe a flow-through implementation, as opposed to flow-over or flat plate implementation of the sorption layer. While flow-over or flat plate implementations could be employed without departing from the scope of this invention, it can be preferable to keep the boundary layers small with a high degree of percolation for example as can be provided in porous flow-through bodies, units or layers. A porous sorption unit or layer comprising hygroscopic material(s), can absorb thermal energy (e.g., radiative solar thermal energy) and release captured water vapor to a working or regeneration fluid, for example during a desorption/release operational mode or cycle. In one example, a hygroscopic material and/or hygroscopic composite can be arranged within a flow distributor, such as but not limited to a lattice structure, top and bottom rigid porous plates, inter-corrugated fluidic channels, interdigitated fluidic channels, and/or woven and fiber meshes to sustain back pressure and distribute the flow. A hygroscopic composite can be provided as a composite assembly such that its structure provides the system with structural properties, pressure drop, flow paths, and/or thermal properties.

System 100 further comprises heat exchange assembly 130 below a second side provided as solar electric portion 112b. In such an implementation, a PV panel or layer of second side provided as solar electric portion 112b can collect solar radiation to convert it to electrical energy. As such, solar radiation is converted to solar electric energy at second side provided as solar electric portion 112b of system 100, whereas solar radiation directly heats sorption layer (e.g., 118a-b) via a transparent cover layer of first side (e.g., 112a). In some implementations, it can be preferable to include one or more insulation layer(s) between heat exchange assembly 130 and PV layer (e.g., 114).

A unit, sorption body or layer can receive heat from at least one thermal source, for example a regeneration gas, solar radiation, a photovoltaic cell, a heater, a heat exchanger and/or the like. A regeneration fluid or gas can accumulate heat and water vapor upon flowing across or through the sorption layer 118 and then be cooled upon flowing through the heat exchange assembly 130 to condense water therefrom before returning to sorption layer to accumulate more heat and water vapor (i.e., in a closed loop flow path within system 100).

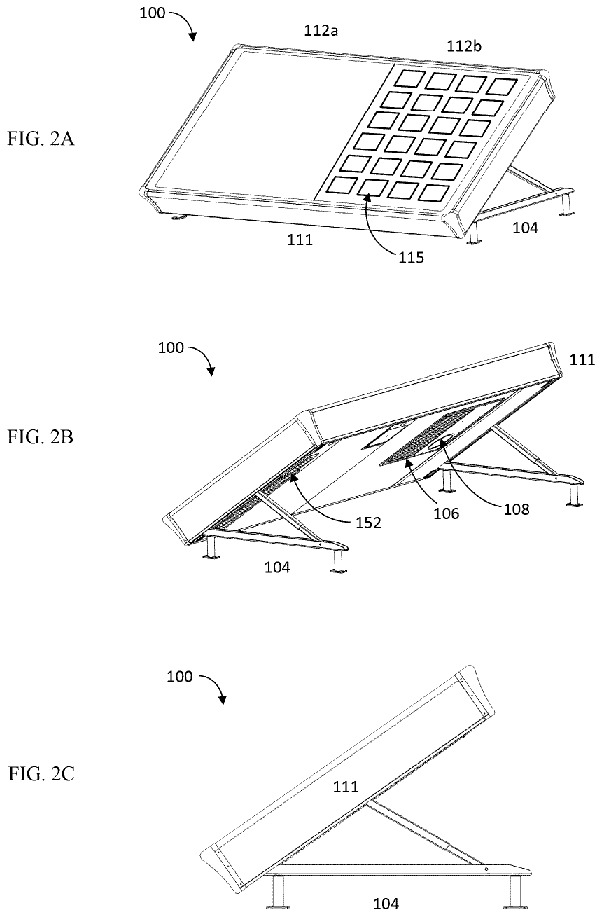

FIG. 2A-C depict water generation system 100 installed on a mounting surface, which can be accomplished for example by one or two people. FIG. 2A depicts a front perspective view, FIG. 2B depicts a rear perspective view and FIG. 2C depicts a side view of water generation system 100 installed at an angle on a horizontal mounting surface (e.g., flat roof, ground). Water generation system 100 can comprise a support assembly or mounting assembly 104 that can be oriented and installed on a surface to receive incoming solar radiation, for example in a fixed tilt configuration. While FIG. 2A-C depict water generation system 100 installed at an angle on a substantially horizontal mounting surface, water generation system 100 can alternatively be mounted on an inclined surface (e.g., sloped roof of a structure) with or without the use of an adjustable mounting assembly. System 100 can be installed or mounted above a ground surface or rooftop via adjustable mounting assembly 104 which extends from the system housing to position the system in a fixed tilt configuration at an angle relative to a substantially horizontal ground surface or flat rooftop. System 100 can be oriented toward the southern sky for an installation in the Northern Hemisphere, or toward the northern sky for an installation in the Southern Hemisphere. The descriptive terms used herein such as front, rear, above, below, top, bottom, over, under, etc. are used to aid understanding of the invention are not used in a limiting sense. Furthermore, the directions north, south, east and west may be used herein assuming the installation site is in the Northern Hemisphere, however opposite directions can be used for installations in the Southern Hemisphere without departing from the spirit and scope of the present disclosure.

The exposed solar collection area, or geometric area, at the front surface of the water generation system can be apportioned for solar thermal energy and solar electric power generation such that an autonomous, self-powered and compact water generation system is possible. A water generation panel having a compact and slim geometry while maintaining a high or maximized water production capability (e.g., greater than 4 liters per day, greater than 6 liters per day, greater than 8 liters per day, greater than 10 liters per day and/or greater than 15 liters per day) can be desirable and as such, its front surface area facing the sun can be considered as a constraint or boundary condition (i.e., in combination with water production requirements). For example, within the confines of the water generation system geometry, the front surface area (e.g., 1-3.5 m², 0.5-4 m², less than 4 m², less than 3.5 m², equal to or less than 3 m2) of the water generation system can be apportioned or split between a solar thermal generation area (e.g., indicated by 112a) and solar electric generation area (e.g., indicated by 112b). The ratio of the solar thermal to solar electric collection area, or the percentage of the front surface area for solar thermal conversion vs the percentage of the front surface area for solar electric conversion, is constructed such that a water production efficiency or water production amount or rate is maximized (e.g., amount of daily water production is greater than 4 liters per day, greater than 6 liters per day, greater than 8 liters per day, greater than 10 liters per day and/or greater than 15 liters per day) in a compact and/or slim panel geometry.

Water generation systems of the present technology can include 10-90%, 20-80% or 40-60% of the front surface area for solar thermal generation with 10-90%, 20-80%, or 40-60% of the front surface area for solar electric generation. As an illustrative example, in installation regions having lower average ambient temperatures, it may be preferable to deploy a water generation system having a greater area for solar thermal generation (e.g., 112a) than the area for solar electric generation (e.g., 112b) so as to increase heating of the sorption layer.

As depicted in FIG. 2A-C, support assembly 104 comprises a plurality of adjustable or collapsible mounting arms that can support the water generation system at fixed angle above the mounting surface (e.g., ground surface or rooftop). The mounting arms can retract or fold into housing 111, for example during transport or storage. The mounting arms of support assembly 104 can extend from the housing 111 and engage or interlock into a fixed position to securely orient the front surface of system (e.g., front surface 112) at fixed tilt angle to face a southern direction, for example when installed on a flat or horizontal mounting surface. An adjustable mounting assembly can include arms that operate using a variety of mechanisms, such as a pneumatic arms providing smooth motion through gas compression, or spring-loaded arms offering simple and cost-effective adjustability, arms having friction-based joints and/or the like. When in an installed state, the system 100 can be supported at an angle relative to the mounting surface and also allow for ambient air intake and/or exhaust from a rear panel of the housing 111 (e.g., via loading inlet 106 for inputting process gas and loading outlet 108 for exhausting process gas). In other embodiments, a support assembly may not be present, or may not be employed during installation, for example when mounting the system on a sloped roof. The embodiments depicted in FIGS. 2A-C and 3A-B depict loading inlet 106 and loading outlet 108 disposed at the rear side of panel. However, in other embodiments, the inlet(s) and/or outlet(s) can be disposed at one or more sides of the panel.

In various embodiments, one or more filters can be provided to filter process gas (e.g., remove contaminants like dust and the like from ambient air) in advance of input to the water generation system. For example, a replaceable or serviceable filter tray (e.g., indicated at 106) can mate (e.g., slide) into a housing receptacle to cover process or ambient air inlet 106. In various embodiments, one or more replaceable air filters can be provided as part of a housing assembly, a system fan assembly and/or a valve assembly, to filter ambient air in advance of ingress into system 100 during a sorption cycle. As another example, a replaceable or serviceable filter tray (e.g., indicated at 152) can mate (e.g., slide) into a housing receptacle to cover cooling flow or ambient cooling air inlet during a desorption cycle.

Heat exchange assembly 130 comprises a condenser 150 to condense water from the regeneration fluid via heat transfer from the regeneration fluid to ambient environment and/or a cooling fluid (e.g., ambient air flow through condenser). Heat exchange assembly 130 further comprises recuperator 140 to transfer heat from a first hot-side regeneration fluid flow output from the sorption layer 118 to a second cold-side regeneration fluid flow output from the condenser 150. The term recuperator or recuperative heat exchanger refers to a type of heat exchange unit that has separate flow paths for each fluid throughout its passages and heat is transferred through separating walls.

In various implementations, assembly 130 can be referred to as an enthalpy exchange or transfer assembly, heat exchange or transfer assembly and/or energy exchange or transfer assembly. As such, an exchange or transfer assembly (e.g., 130) can comprise one or more of: 1) passive sensible heat transfer units or subassemblies (e.g. a heat exchanger), 2) passive latent energy transfer units or subassemblies (e.g. vapor transfer membrane, vapor permeable membrane), 3) passive total heat transfer (i.e. sensible and latent energy) transfer units or assemblies (e.g. rotary desiccant wheel), and/or 4) active heat transfer units or subassemblies (e.g., refrigeration unit, vapor compression cycling unit and/or the like). In some implementations, both heat (i.e. sensible) energy and moisture (i.e. latent) energy are transferred or exchanged by the assembly 130. In other implementations, only sensible heat is exchanged, for example with a conventional heat exchanger. Sensible heat can be transferred in the form of a temperature difference between flow segments. Latent heat can be transferred in the form of a moisture difference (e.g., concentration gradient, water vapor partial pressure gradient) between different fluid flow segments. In some implementations, assembly 130 can comprise a plurality of sub-units or sub-assemblies, for example a heat exchange sub-unit and a moisture exchange sub-unit, and/or multiple heat and/or moisture exchange sub-units. In one example, exchange surfaces, elements or plates (e.g., 131) of the recuperator and/or condenser can facilitate transport of water vapor across adjacent flow layers via vapor permeable air barriers or membranes (e.g., expanded polytetrafluoroethylene (PTFE)).

In various embodiments, heat exchange assembly is provided as a unitary device with distinct sections optimized for recuperative heat transfer and water condensation encapsulated in a slim and low-profile structure. The heat exchange assembly can comprise thin heat exchange plates for flowing regeneration fluid flow in recuperative heat exchange portion (e.g., 140) and condensation portion (e.g., 150) set in a geometry to enhance heat transfer from hot-side regeneration fluid to cold-side regeneration fluid (i.e., in recuperative section) and the ambient environment (i.e., in condenser section) for efficient water production.

The heat exchange assembly layers, which can also be referred to as a “ministack”, are defined and organized to minimize spatial requirements within the larger system structure, thereby driving water production performance and spatial efficiency. Furthermore, “ministack” heat exchange assemblies disclosed herein can have the advantage of simplifying manufacturing enabling scale and reducing overall system costs. In one example, a slim or low profile water generation system can be realized at least in part due to thin heat transfer plates, for example below 2 mm, below 1 mm and/or in the range of 0.2 to 1 mm, 0.4 mm to 0.8 mm, 0.5 to 0.8 mm in thickness, with flow channels or layers having spacing less than 12 mm, less than 10 mm, between 4 mm to 12 mm, and/or between 6 mm to 10 mm. Furthermore, the number of flow channels or layers can vary between 4 to 8 layers. As such, the overall thickness of the heat exchange assembly can range between 8 cm to 18 cm, and in turn the overall thickness of the water generation system can range between 10 cm to 25 cm.

Various features can be provided to enhance condensation efficiency in the heat exchange assembly. For example, condenser surface treatments can be provided to increase hydrophobicity and facilitate dropwise condensation. The application of hydrophobic coatings (e.g., fluorinated coatings, epoxy coatings selected for safety in contact with drinking water that may be under regional regulations or standards) on condenser surfaces can promote droplet formation and facilitate the shedding of condensed water, thereby minimizing the occurrence of filmwise condensation. Additionally, macrogeometric features such as microfins and/or enhanced surface roughness can increase the available surface area for condensation and promote transport of condensate away from the heat transfer areas. Features configured for thermal and vapor boundary layer disruption, such as flow diverters within the condenser unit, can be included to increase heat transfer rates by preventing laminar boundary layers and/or contribute to “effective” condenser area by redirecting the flow of the condensing vapor and enhancing contact with the heat exchange surfaces.

In various implementations, a recuperator and/or the condenser can comprise a plurality of longitudinally extending heat exchange plates defining alternating flow layers. For example, recuperator 140 comprises a plurality of longitudinally extending heat exchange plates defining alternating flow layers of a first hot-side regeneration fluid flow output from the sorption layer 118 and a second cold-side regeneration fluid flow output from the condenser 150.

As depicted, condenser 150 comprises a plurality of longitudinally extending heat exchange plates defining alternating flow layers of regeneration fluid output from the recuperator 140 to ambient air cooling flow. As such, the condenser 150 exchanges heat between the regeneration fluid and ambient air and the recuperator 140 exchanges heat between the ‘hot-side’ regeneration fluid in advance of the condenser and the ‘cold-side’ regeneration fluid output from the condenser so as to pre-cool the regeneration fluid before it enters the condenser and to pre-heat the regen air before it returns to sorption layer 118 (after water has extracted from the regeneration fluid in the condenser).

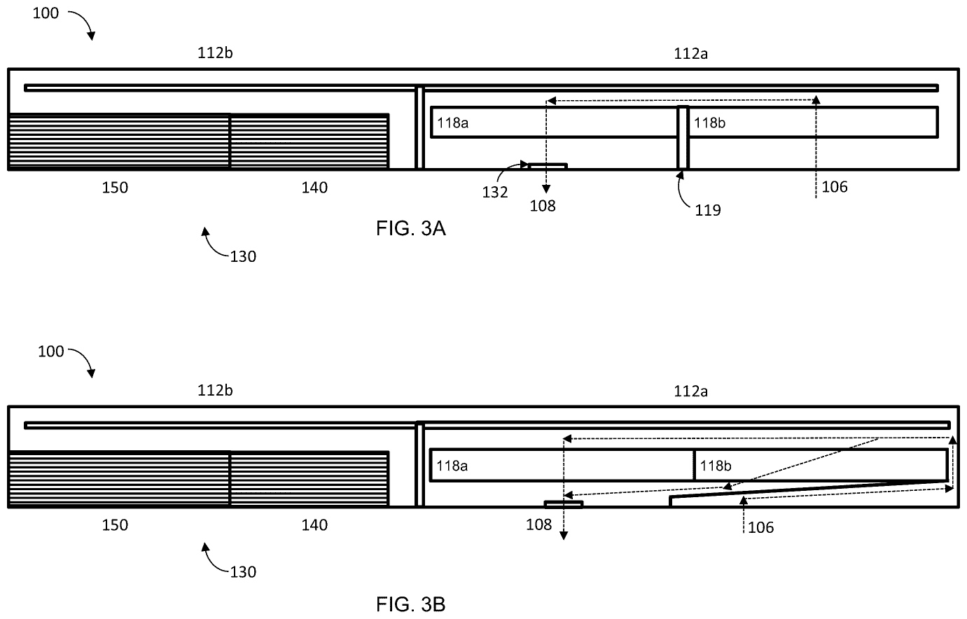

FIG. 3A and FIG. 3B illustrate water generation system 100 having a low profile or compact panel configuration during a sorption, uptake or loading operational mode or cycle. FIG. 3A depicts a series process flow path (indicated by dashed arrows) wherein the process gas flows through sorption bodies 118a and 118b sequentially or ‘in series.’ Separator 119 positioned between sorption bodies 118a and 118b can direct flow in a series configuration. FIG. 3B depicts a parallel process flow path (indicated by dashed arrows) wherein the process gas flows through sorption bodies 118a and 118b concurrently or ‘in parallel.’ While two sorption bodies 118a and 118b without any separator or divider are depicted, a single unitary sorption unit, body or layer can also be employed.

System 100 comprises a controller 170 to increase the relative humidity in the regeneration fluid output from the sorption bodies 118a and 118b to drive condensation of water vapor in the condenser, thereby producing liquid water during the desorption mode. A system controller (e.g., 170) can be configured to determine and/or adjust the flow rate of process gas through the water generation system, for example based on or in response to a change or threshold ambient temperature or humidity, time of day, amount of water produced, a solar insolation or irradiance, a power availability, periods of high ambient relative humidity, periods of energy surplus, periods of low ambient temperature, and/or the like). A controller can set or reduce the process gas flow rate or power input or usage level to reduce or minimize power consumption such that the length of loading mode or cycle is extended without increasing an onboard battery capacity and/or other power source requirement of the system which can result in a greater amount of water capture and generation for a given loading mode or cycle. Furthermore, a system controller (e.g., 170) can determine and/or adjust the flow rate of a regeneration fluid through the water generation system, for example based on or in response to a change or threshold temperature or humidity of the regeneration fluid, time of day, amount of water produced, a solar insolation or irradiance, a power availability and/or the like). A system controller (e.g., 170) can determine if a solar insolation, system water content (e.g., absolute humidity of regeneration fluid, relative humidity of regeneration fluid, equilibrated water of hygroscopic materials and/or the like) and/or temperature of the regeneration fluid flowing in the regeneration flow path is above a predetermined threshold (e.g., via a sensor, via calculation or estimation based on amount of captured or produced water and/or the like), a power availability (e.g., battery state-of-charge (SOC), PV power).

A process gas such as ambient air can be directed into water generation system along a process or loading flow path in the housing (such as indicated by dashed arrows of FIG. 3A or FIG. 3B) via a fan assembly (e.g., fan 132), a valve assembly and/or the like. System 100 uptakes water vapor from the process gas upon flow through sorption bodies 118a and 118b) during a sorption or loading operational mode before being exhausted to the ambient environment. In various embodiments, a fan and/or valve assembly can adjust the flow rate of the process gas by controller 170.

FIG. 4A, FIG. 4B and FIG. 4C illustrate water generation system 100 having a low profile or compact panel configuration during a desorption, release or unloading operational mode or cycle. FIG. 4A depicts a series regeneration flow path (indicated by dashed arrows) in the housing wherein the regeneration gas flows through sorption bodies 118a and 118b sequentially or ‘in series.’ FIG. 4B depicts a parallel regeneration flow path (indicated by dashed arrows) wherein the regeneration gas flows through sorption bodies 118a and 118b concurrently or ‘in parallel.’ FIG. 4C depicts a series regeneration flow path (indicated by dashed arrows) and a PV layer positioned at a top surface, such as to optimize the tradeoff between the electrical and thermal energy outputs of the PV layer.

As depicted in FIG. 4A, FIG. 4B and FIG. 4C, a regeneration flow path (indicated by dashed arrows) can be entirely, or at least partially, closed-loop and can include multiple flow segments through system 100 including: 1) a regeneration flow path segment along upper layer 112 (e.g., to collect heat from top cover layer glazing and/or PV panel(s)); 2) a regeneration flow path segment within sorption layer 118 (e.g., during which the regeneration fluid uptakes heat and water vapor upon flow through sorption bodies 118a and 118b); 3) a hot-side regeneration fluid flow segment exiting sorption layer 118 and through recuperator 140 (e.g., being cooled so as to condense water vapor from the regeneration fluid); 4) a regeneration flow segment through condenser 150 (e.g., condensation of water vapor via ambient air cooling); and, 5) a cold-side regeneration fluid flow segment through recuperator 140 before returning to a upper layer 112 (e.g., for reheating before flowing again through sorption layer 118).

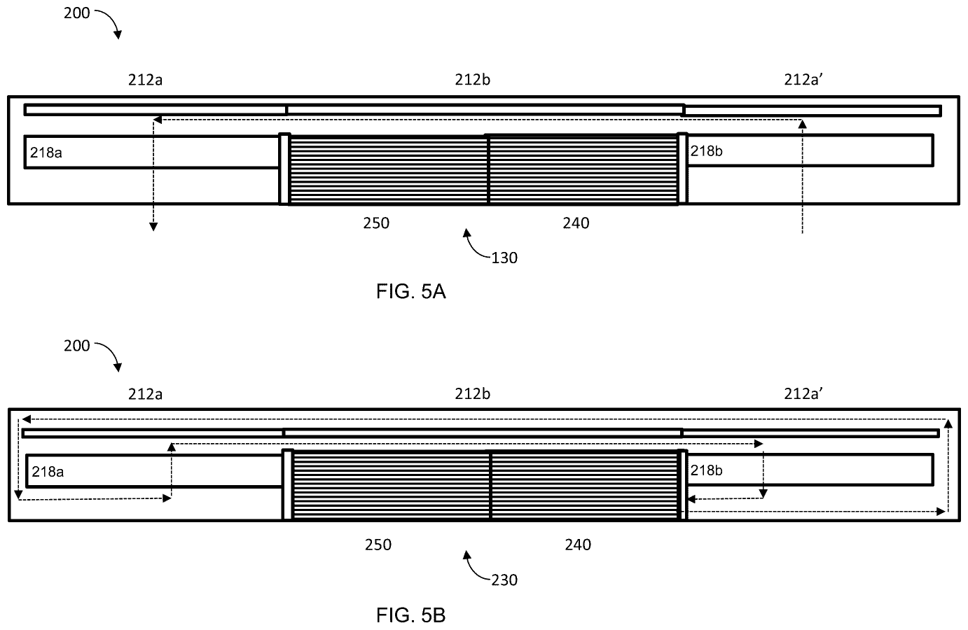

Water generation system 100 comprises an offset panel configuration including sorption bodies offset, or side-by-side, in relation to a heat exchange assembly (in addition to offset or side-by-side solar thermal and solar electric upper or top layers), however other system configurations are possible. For example, FIG. 5A and FIG. 5B depict a water generation system 200 comprising a symmetric or centered configuration wherein heat exchange assembly is positioned between sorption bodies 218a and 218b. Furthermore, a central solar electric upper layer 212b is positioned between solar thermal upper layers 212a and 212a′.

FIG. 5A depicts a series process flow path in a water generation system 200 during a sorption cycle and FIG. 5B depicts a series regeneration flow path in a water generation system 200 during a desorption cycle. Unless otherwise specified, the numerical indicators used to refer to components in water generation system 100 are similar to those used to refer to components or features of water generation system 200, except that the index has been incremented by 100.

Disclosed heat exchange assemblies can improve a system's overall efficiency by cooling a high temperature incoming fluid or air stream to a temperature closer to a desired temperature via the transfer of thermal energy from a low temperature fluid or air stream. Disclosed heat exchange assemblies allow for efficient transfer of heat from a hot-side flow to a cold-side flow while maintaining isolation of the two flows or streams from each other. Disclosed compact configurations of sorption units and heat exchange assemblies can be desirable, especially for field deployable water generation systems, in order to reduce size and material costs of the system, all while providing high heat exchange effectiveness to maximize heat recuperation and water production.

For maximum heat exchange effectiveness and water production for a compact water generation system, it can be preferable to maximize the area of the heat exchange surfaces in order to maximize the heat transfer capability. In the same compact water generation system, it is desirable to minimize system volume to facilitate deployment. As such, the configurations and approaches disclosed herein can achieve high water production performance in a compact form factor with maximum heat transfer and water capture areas while minimizing backpressure (which in turn drive power demand for fluid flow). Furthermore, the relative orientation of fluid flow in adjacent layers through the heat exchange assembly 130 is presented here for special relevance in water generation technology.

Condenser sections or portions of heat exchange assembly (e.g., condenser 150) of the present technology can include alternating flow layers of regeneration fluid and ambient air cooling flow such that heat is exchanged between the regeneration fluid and an ambient air flow.

In preferred implementations, the regeneration fluid flows in a direction at least partially counter to the direction of ambient airflow (i.e., counter-flow) to drive a higher effectiveness ceiling of water vapor condensation form the regeneration fluid as it cools. In some preferred implementations, the condenser exchanges heat from the regeneration fluid to the ambient environment (e.g., ambient air cooling flow) in a counter-flow arrangement. Furthermore, some implementations can include serpentine, sinuous or otherwise curved flow paths to increase the velocity of the cooling fluid and/or regeneration fluid flowing through the condenser.

The recuperative heat exchange portions or sections (e.g., recuperator 140) of the present technology can be provided in various orientations to transfer heat from hot-side regeneration fluid flow output from the sorption layer and cold-side regeneration fluid flow output from the condenser. Furthermore, heat exchange assembly can be provided as a single or multiple pass system and furthermore, comprise counter-flow, partially counter flow, parallel flow sections and any combination thereof.

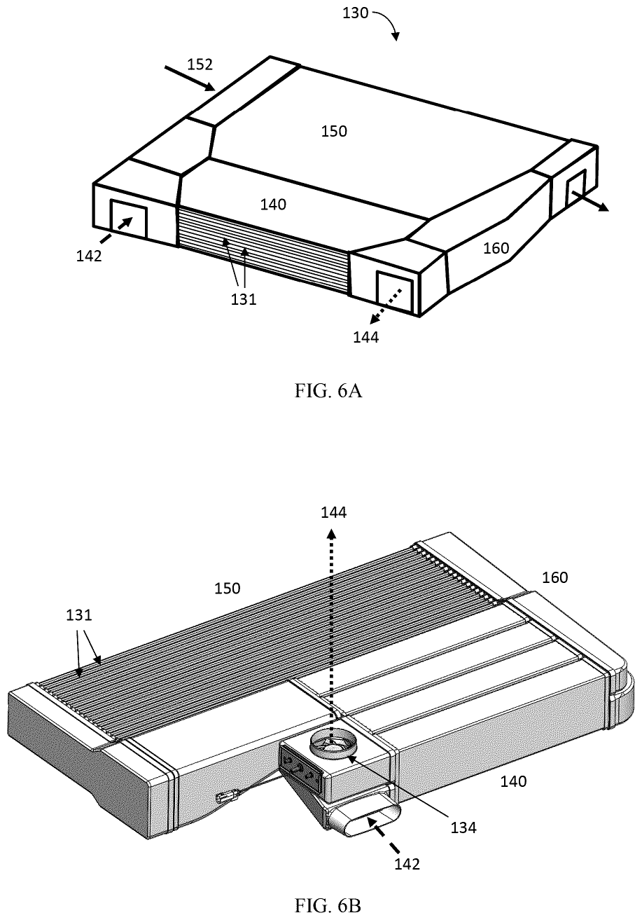

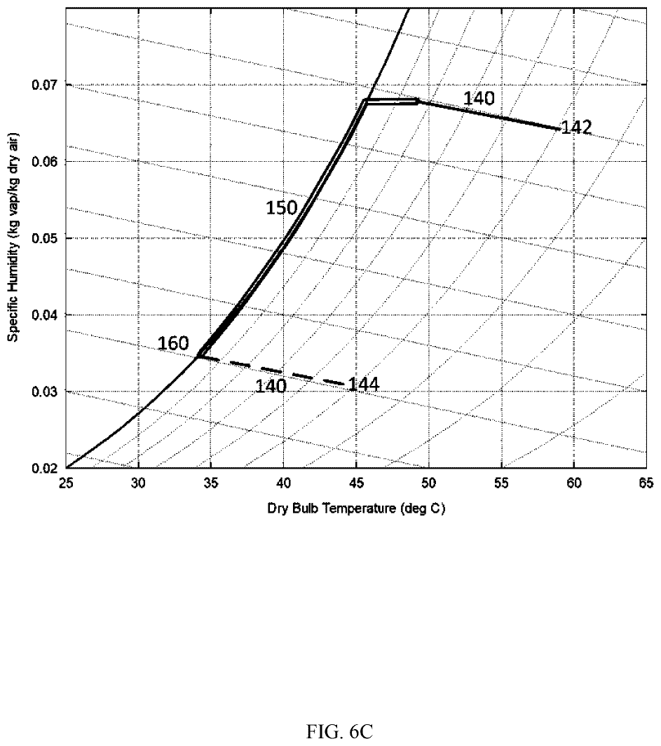

FIG. 6A illustrates a side perspective view of an exemplary heat exchange assembly 130 having a first or “hot-side” regeneration fluid flow 142 (indicated by long dashed lines) input to recuperator 140, and a second or “cold-side” regeneration fluid flow segment 144 (indicated by short dashed lines) output from recuperator 140 upon flow through heat exchange assembly 130 (e.g., via one or more fans or blowers such as fan 134). During the desorption cycle, heat exchange assembly can be cooled by a cooling fluid (e.g., ambient air) directed in cooling flow path including one or more cooling layers (e.g., via one or more fans or blowers such as fan 136). Ambient air can be directed into the system to flow in cooling flow path 152 at least partially defined by longitudinally extending heat exchange plates of condenser 150. The cooling flow path 152 (indicated by solid lines) can direct ambient air in a direction at least partially counter to the flow direction of the hot-side regeneration fluid flow 142 (indicated by long dashed lines) in an adjacent layer before being exhausted to the outside environment. In some implementations, it can be preferable to include one or more insulation layer(s) between a cooling flow path (e.g., 152) and the regeneration flow path flow behind or below the PV layer (e.g., 114). Furthermore, the system can include a liquid water reservoir 160 to collect and/or output liquid water condensed from the regeneration fluid in the condenser 150 during the desorption cycle.

In a related implementation, FIG. 6B depicts another heat exchange assembly 130 comprising extruded heat exchange layers for mechanically interlocking which can provide manufacturing efficiencies at high quality and scale such that sub-components are easily fabricated and assembled with minimized cost and waste. Unless otherwise specified, the numerical indicators used to refer to components in FIG. 6B are similar to those used to refer to components or features in FIG. 6A. The heat exchange assembly 130 depicted in FIG. 6B has a first or “hot-side” regeneration fluid flow 142 (indicated by long dashed lines) input to recuperator 140, and a second or “cold-side” regeneration fluid flow segment 144 (indicated by short dashed lines) output from recuperator 140 upon flow through heat exchange assembly 130 including condenser 150 (e.g., via one or more fans or blowers such as fan 134). In some implementations, the liquid water reservoir 160 of heat exchange assembly 130 can feed to a larger water reservoir and/or contact tank, either onboard or a tank separate from system 100, for sanitation (e.g., via ozone, chlorine), mineralization (e.g., via calcium, magnesium or addition of other water quality or taste compounds) and/or storage. In some implementations, liquid water reservoir 160 can function as a sump or short term water collection reservoir, for example is to collect and temporarily store condensed water before being pumped or drained out to a user.

In some embodiments, system 100 is coupled to (e.g., via tubing or plumbing) a recirculation system, water tank or storage reservoir for receiving produced liquid water from system 100, for example via a liquid water dispensing outlet. Water output from system 100 can be pure and lack minerals, similar to “distilled” water or can be similar to “mineral water” i.e., purified water with additive minerals, for example added to the water after condensation. In various embodiments, system 100 comprises additional peripheral components to facilitate autonomous, compact and/or slim deployment including but not limited to components for onboard water treatment, water mineralization, water sanitation and/or the like.

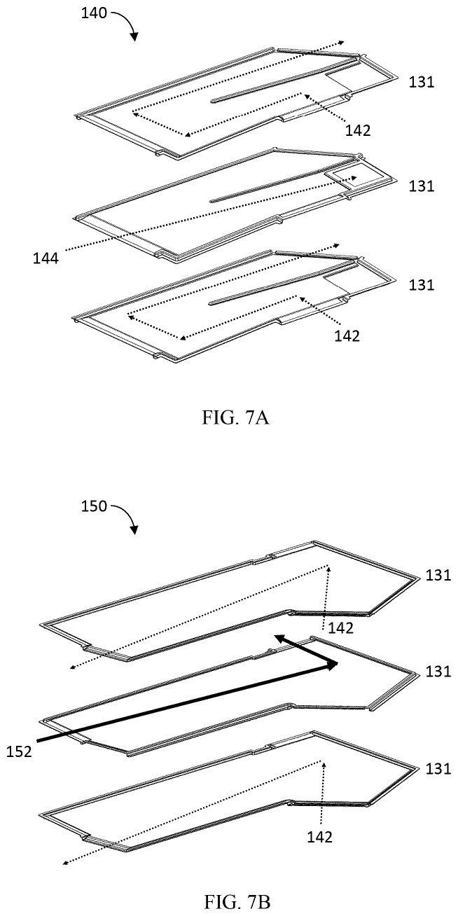

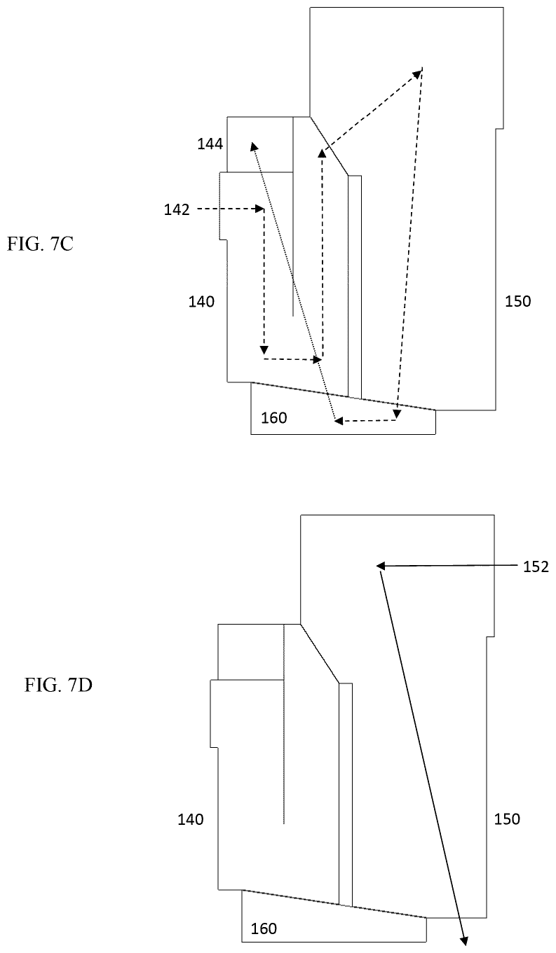

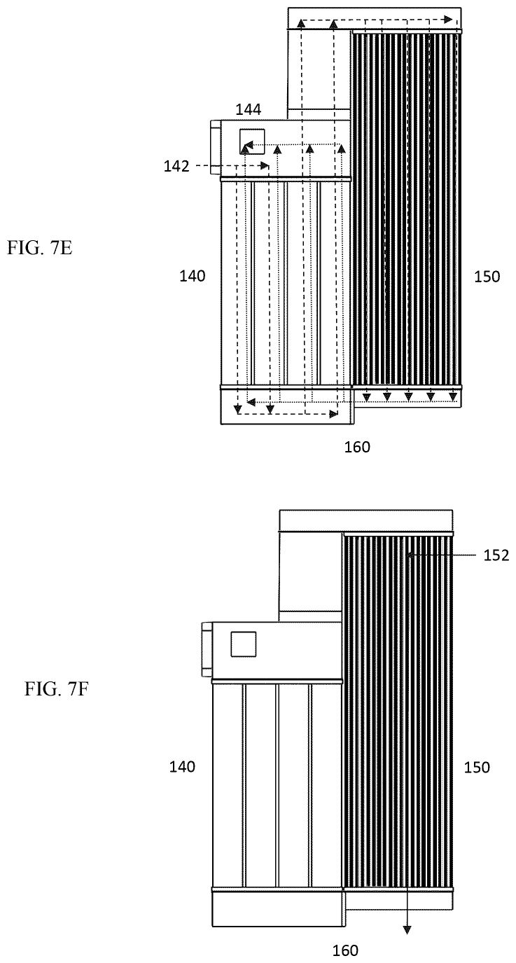

The heat exchange assembly 130 (and similarly, the recuperator 140 and condenser 150) can comprise a plurality of longitudinally extending heat exchange surfaces, elements or plates (e.g., 131) arranged in a spaced relation (e.g., stacked, vertically spaced and/or the like) to at least partially define a plurality of flow channels or layers (e.g., alternating hot-side/cold-side flow layers, alternating hot-side/cooling fluid flow layers, and/or the like). As depicted in FIG. 7A, longitudinally extending heat exchange plates can at least partially define first or hot-side regeneration flow (e.g., 142) layers alternating between second or cold-side regeneration flow (e.g., 144) layers in the recuperator 140. As depicted in FIG. 7B, longitudinally extending heat exchange plates can at least partially define first or hot-side regeneration flow (e.g., 142) layers alternating between cooling flow (e.g., 152) layers in condenser 150.

A top-down view of a single flow layer of heat exchange assembly 130 of FIG. 6A is depicted with a regeneration fluid flow in FIG. 7C and with a cooling fluid flow in FIG. 7D. Similarly, a top-down view of a single flow layer of heat exchange assembly 130 of FIG. 6B is depicted with a regeneration fluid flow in FIG. 7E and with a cooling fluid flow in FIG. 7F. A first or “hot-side” regeneration fluid flow 142 (indicated by long dashed lines) is input to recuperator 140, and a second or “cold-side” regeneration fluid flow segment 144 (indicated by short dashed lines) is output from recuperator 140 upon flow through heat exchange assembly 130 including condenser 150 (e.g., via one or more fans or blowers such as fan 134). During the desorption cycle, heat exchange assembly can be cooled by a cooling fluid (e.g., ambient air) directed in cooling flow path including one or more cooling layers. Ambient air can be directed into cooling flow path 152 at least partially defined by longitudinally extending heat exchange plates of condenser 150. The cooling flow path 152 (indicated by solid lines) can direct ambient air in a direction at least partially counter to the flow direction of the hot-side regeneration fluid flow 142 in an adjacent layer before being exhausted to the outside environment. Cooling fluid is depicted flowing in a first direction, however cooling fluid flow can be reversed so as to flow in the opposite, orthogonal, or out of plane directions, or a mixture thereof.

While longitudinally extending heat exchange surfaces or plates of the recuperator and condenser are arranged in parallel in the examples provided herein (such as depicted in FIG. 4A-C and FIG. 6A-B), alternative configurations are also possible. For example, heat exchange surfaces or plates of the recuperator can be arranged perpendicular to heat exchange surfaces or plates of the condenser which can be preferred in configurations with shorter flow paths and/or minimizing pressure drop. Furthermore, it may be preferable for longer flow path lengths in the condenser relative to flow path lengths in the recuperator, for example to promote dropwise condensation.

A first or hot-side regeneration fluid flow layer at a first or higher temperature (e.g., greater than 40° C., greater than 60° C., greater than 70° C., between 40-80° C.) can direct a first or hot-side regeneration fluid flow 142 in a direction at least partially counter to a flow direction of a second or cold-side regeneration fluid flow segment 144 at a second or lower temperature (e.g., less than 70° C., less than 60° C., less than 40° C., between 20-60° C.) in an adjacent cooling flow layer to establish a counter-flow heat exchange relation therebetween.

Furthermore, a first or hot-side regeneration fluid flow layer at a first or lower humidity or moisture content (e.g., less than 30% RH, less than 40% RH, between 30-60% RH) can direct a first or hot-side regeneration fluid flow 142 in a direction at least partially counter to a flow direction of a second or cold-side regeneration fluid flow segment 144 at a second or higher humidity or moisture content (e.g., greater than 70% RH, greater than 80% RH, between 70-100% RH in an adjacent cooling flow layer to establish a counter-flow heat exchange relation therebetween.

To illustrate an operation of heat exchange assembly 130, FIG. 6C shows a psychrometric chart including process path lines for an exemplary process including temperature and humidity changes in a fluid (e.g., regeneration fluid) flowing through the recuperator 140 and condenser 150. The first or hot-side regeneration fluid flow 142 is input to recuperator 140 and flows therethrough until reaching the dewpoint or saturation line (i.e., RH=100% RH). The fluid input to recuperator (indicated at 142 in FIG. 6C) can represent an example state of the regeneration fluid where the starting or ambient condition could be 25° C., 60% RH and 1000 W/m² solar power, as an illustrative example. The initial state or starting point of the temperature at 142 will depend on the ambient temperature and solar power (higher in both translate to hotter temperatures which in this example would be 60° C. dry bulb temperature of fluid input). The specific humidity initial state or starting point will depend on the ambient relative humidity which in this illustrative example is 0.065 kg water vapor per kg dry air. Liquid water is condensed from the fluid flowing in condenser down saturation line (i.e., indicated at 150 in FIG. 6C) to be collected and/or output at 160. The second or cold-side fluid flow (indicated by dashed path line from 160 to 144 in FIG. 6C) flows through recuperator 140.

FIG. 6C depicts how the fluid or air state changes from fluid flow input to recuperator at 142 until flow through condenser 150 for condensation to form liquid water. In the example of FIG. 6C, total enthalpy is exchanged (i.e., both sensible and latent energy), so both temperature and specific humidity change. If the recuperator is a sensible heat exchanger (e.g. air to air heat exchange across thin solid sheets), then the process path line through 140 will be horizontal in a psychrometric plot as no water content change would occur. The transition point between 140 and 150 depends on the conditions stated above i.e., how much heat and water are rejected from the condenser 150 dictate the thermal boundary conditions of entry point indicated at 142 into recuperator 140, and the exit point indicated at 160 from the condenser 150. Energy balance dictates that the path lines drawn on the psychrometric plot for both trips i.e., first or ‘hot-side’ and second or ‘cold-side flow segments through recuperator 140 to be equal and parallel. Fluid output from recuperator at 144 can then be returned back to the solar layers for reheating (e.g., starting with solar electric portion 112b).

The heat exchange layers or passes can be stacked both above and below one another in an alternating manner to form multiple parallel flow paths for each fluid flow, with heat exchange surfaces (e.g., heat exchange plates) located between hot and cold flow segments or streams. In some embodiments, the heat exchange plates and/or surfaces can be composed of or comprise a polymeric material (e.g., thin plastic plates). Furthermore, some heat exchange assemblies can be entirely made of plastic or polymeric materials. In other embodiments, the heat exchange surfaces can be composed of or comprise metallic material (e.g., thin aluminum plate). In yet other embodiments, the heat exchange surfaces can be composed of or comprise a combination of polymeric material(s) and metallic material(s).

As an illustrative example, the heat exchange assembly can be manufactured by a thermoforming process to facilitate formation of flow control features and structural spacers into a small form factor or slim geometry for a water generation panel. The thermoforming process can also facilitate minimal thickness of heat exchange plates to define adjacent flow layers. Other manufacturing methods to create parallel flow channels can also be employed, for example plastic extrusion, injection molding, and blow molding. Plastic extrusion can be a cost effective way to get high surface area and thin heat transfer plates, but can be challenging to process materials facilitating high water quality and high temperatures. Additionally, plastic extrusion may limit formation of flow control features for flow uniformity in the layers. While injection molding or blow molding processes can be employed, it can be challenging to produce thin heat transfer plates, for example with thickness below 2-3 mm, with large surface areas. As such, thermoforming methods for manufacturing the heat exchange assembly may be preferable to produce thin, high surface area heat transfer plates (e.g., below 2 mm, below 1 mm, 0.2 to 1 mm, 0.4 mm to 0.8 mm, 0.5 to 0.8 mm in thickness) and water-safe materials (e.g., Polyethylene Terephthalate, High or Low-Density Polyethylene, Polyvinyl Chloride, Polypropylene and/or the like).

Heat exchange assemblies of the present technology can be designed to integrate both 1) a recuperation function (e.g., at least partial counter-flow heat exchange between hot-side and cold-side segments a closed loop regeneration flow); and 2) transfer heat to the ambient environment from a regeneration fluid flowing in a closed-loop to drive condensation therefrom, wherein a cooling fluid such as ambient air flows through the system in a single pass open-loop flow path.

In other heat exchange systems, the recuperative function can occur sequentially with respect to condensation. However, the present technology can have advantages, especially for a compact, off-grid water generation system, in that the condensation layer(s) allow for continued recuperation while at the same time collecting and routing fluid flow for ambient air-cooled heat exchange in the condenser. Furthermore, the disclosed approach can integrate ambient air cooling (e.g., via ambient air flow from external environment that can also be a process gas from water vapor is absorbed for water generation) and recuperative cooling in a layered flow architecture having collection or manifolding of flow within the layers (e.g., enabled by alternating spacers or flow directing elements) as opposed to collecting flow externally via a boxed or separate structure, flow rerouting and/or the like.

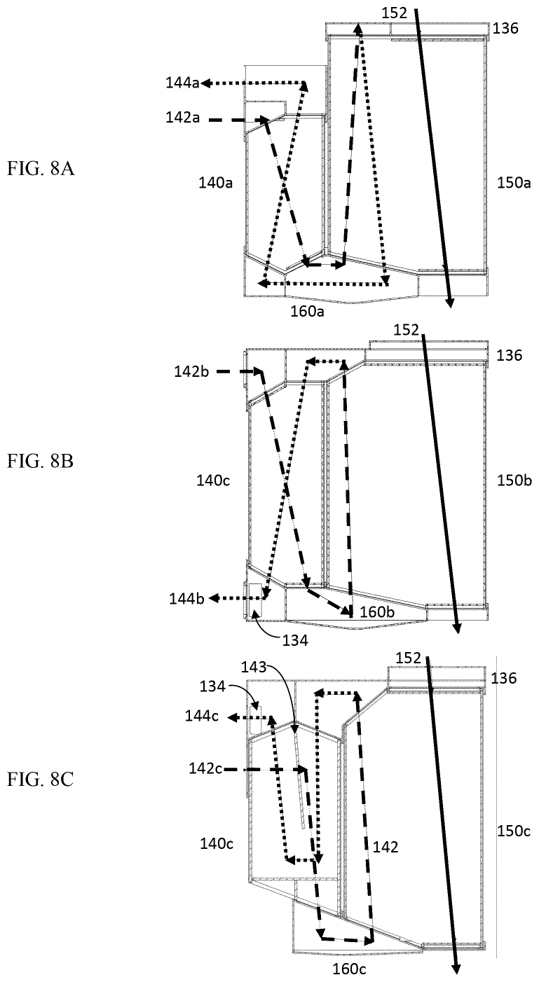

To further illustrate some possible implementations of the present technology, FIG. 8A-C depict various configurations and associated flow architectures for heat exchange assembly 130 as illustrated in a top-down view with a single flow layer for ease of description. FIG. 8A depicts a recuperator 140a having a counter-flow arrangement in combination with a counter-flow condenser 150a, FIG. 8B depicts recuperator 140b having a parallel flow arrangement in combination with a counter-flow condenser 150b, and FIG. 8C depicts recuperator 140c having a hybrid flow arrangement in combination with a counter-flow condenser 150c.

The term “counter-flow” can refer to configurations where hot-side fluid and cold-side or cooling fluid flow in opposite directions, whereas the term “parallel-flow” can refer to configurations where hot-side fluid and cold-side or cooling fluid flow in the same direction. The term “cross-flow” can refer to configurations where hot-side fluid and cold-side or cooling fluid flow at 90° angles (i.e., perpendicular) to each other. In various embodiments, hot-side fluid and cold-side or cooling fluid flow in at least partially counter-flow, partially parallel-flow or partially cross-flow directions. Furthermore, a “hybrid” flow arrangement can refer to a flow configuration wherein a first section is configured for at least partially counter-flow and a second section is configured for at least partially parallel flow, for example as shown in recuperator 140c in FIG. 8C.

The hybrid flow recuperator of FIG. 8C comprises a flow directing element 143 (e.g., divider or separator situated perpendicular in a flow layer) to create a turn in the regeneration flow path to redirect the regeneration fluid over an angle that may be up to about 180°, including being between about 90° and about 180°. While only one layer is depicted for simplicity, additional layers (e.g., for the hot-side regeneration fluid flow or cold-side regeneration fluid flow) can be employed to transfer heat from the hot-side regeneration fluid flow to the cold-side regeneration fluid flow in a counter-flow or partially counter-flow direction (e.g., left-side section of element 143 in recuperator 140c) and parallel flow direction (e.g., right-side section of element 143 in). While the water generation system at the system level can minimize turns in the regeneration and/or process flow path for uniform flow, incorporating turns for a hybrid flow recuperator can maximize volumetric utilization and spatial efficiency for a low back pressure system.

The water generation system can facilitate efficient organization of components (i.e., solar thermal element(s), solar electric element(s), sorption unit(s), heat exchange assembly) within the confines of the front surface, rear surface and the sidewalls. In implementations where the sorption layer, the condenser and the recuperator are located within the housing, the sorption layer can be positioned adjacent to the recuperator and condenser, the recuperator and condenser being collectively the heat exchange assembly. Furthermore, the solar electric portion (e.g., PV unit or panel) or layer can be positioned above the heat exchange assembly and also adjacent to the solar thermal layer (e.g., one or more transparent layer(s)) to allow solar radiation to impinge directly upon the sorption layer.

The total heat exchange surface area of the heat exchange assembly can be balanced for recuperation and condensation for incorporation into a self-powered and compact water generation system. A compact and slim water generation panel comprising a slim heat exchange assembly for spatial efficiency with the area and/or volume for heat exchange as a constraint or boundary condition. As such, the total heat exchange surface area of the heat exchange assembly is distributed or allocated across recuperative heat exchange surface area and heat exchange surface area for condensation and exhausting heat to the ambient environment. In one example, the total heat exchange surface area of the recuperator is 15-50% of the total heat exchange surface area for the heat exchange assembly (i.e., with the 50-85% balance being for the condenser for condensation and exhausting heat to the ambient environment). In another example, the total heat exchange surface area of the recuperator is 20-30% of the total heat exchange surface area for the heat exchange assembly (i.e., with the 70-80% balance being for condensation and heat exhaust to the ambient environment).

While a maximum heat exchange surface area can further drive condensation of water from the regeneration fluid, there is a point at which an asymptote of efficiency would be reached, after which additional surface area would not improve water generation performance due to increased cost, size and/or increase pressure drop through system which increases power requirements of fans or blowers to flow regeneration fluid through the system.

The distribution of total heat exchange surface area of the heat exchange assembly between recuperator and condenser can be set to maximize heat transfer across all possible installation environments (i.e., solar irradiance, ambient humidity, ambient temperature), or set for particular installation regions or locations based on predetermined solar and ambient conditions. For example, the recuperator arrangement and/or surface area can be provided such that it only does sensible work to get the regeneration fluid output from the sorption unit to its saturation temperature (i.e., dewpoint), and the remainder of the available surface area for heat exchange is used for the condenser, wherein the condenser is air cooled.

It may be preferable to configure the water generation system such that the ratio of recuperator surface area to condenser surface area based on the average ambient environment at the installation location. As an illustrative non-limiting example, the water generation system can be provided such that the total heat exchange surface area of the recuperator is 25-35% of the total heat exchange surface area of the heat exchange assembly (i.e., with 65-75% being the heat exchange surface area for the condenser) for highly efficient water generation in a drier environment where the recuperator primarily functions to perform sensible work. In a humid environment, the water generation system can be provided such that the total heat exchange surface area of the recuperator is 40-50% of the total heat exchange surface area of the heat exchange assembly (i.e., with 50-60% being the heat exchange surface area for the condenser) for highly efficient water generation where the recuperator handles a greater heat load from latent work.

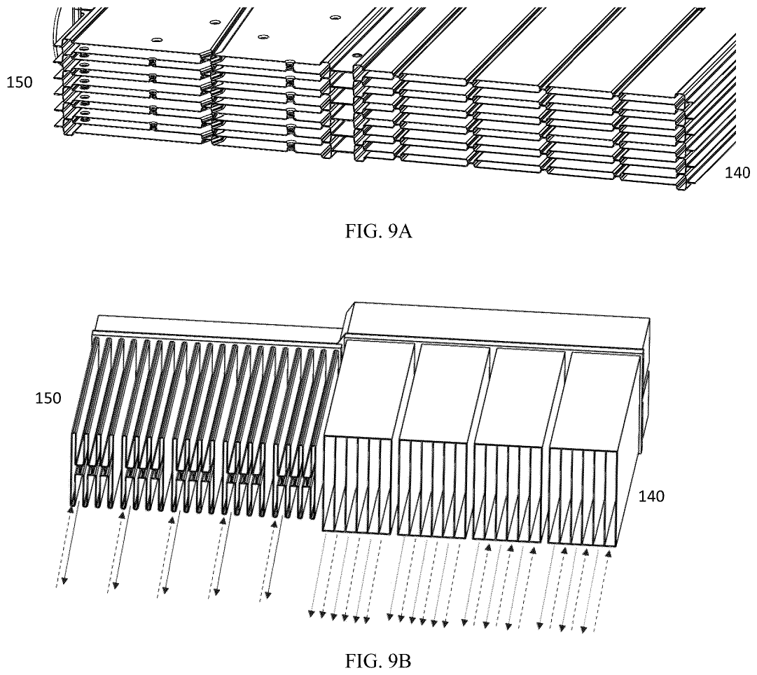

A side perspective view of heat exchange assembly 130 of FIG. 6A is depicted in FIG. 9A having necked or tapered thermoformed channels in both recuperator and condenser portions. In another exemplary implementation, a side perspective view of heat exchange assembly 130 of FIG. 6B is depicted with a hot-side regeneration fluid flow (long dashed lines), a cold-side regeneration fluid flow (short dashed lines), and a cooling fluid flow (solid lines) in FIG. 9B. FIG. 9B depicts heat exchange assembly 130 including a plurality of mechanically interlocking heat exchange layers having a repeating geometry of extrusions that can be mechanically interlocked or socketed together into a flow directing element (e.g., plenum 135, blocker or the like).

Manufacturing or forming linear walls of heat exchange layers or plates can be challenging in terms of precision, reproducibility, wall thickness uniformity, low cost and/or structural strength, especially in applications where long term durability and water compatibility for water harvesting systems is desired. Injection molding of polymeric materials can be employed to produce precise, high-strength linear walls can provide high dimensional accuracy and tight tolerances but can require high initial tooling costs. In some implementations, thermoforming of pre-heated polymeric sheets shaped over a mold can be effective for complex channel shapes, wall thickness uniformity may be reduced. Similarly, compression molding can produce durable heat transfer walls with high material strength but slower cycle times and higher labor requirements may limit its use for high volume application.

Extrusion can be a preferred method for scalable manufacture of continuous linear heat transfer plates or walls in various shapes and configurations via melting polymer pellets through a shaped die to produce a continuous wall profile with uniform cross-section along extended lengths. This process can be highly efficient and cost-effective, especially for high-volume production of simple, consistent wall or plate profiles in extended, linear shapes.

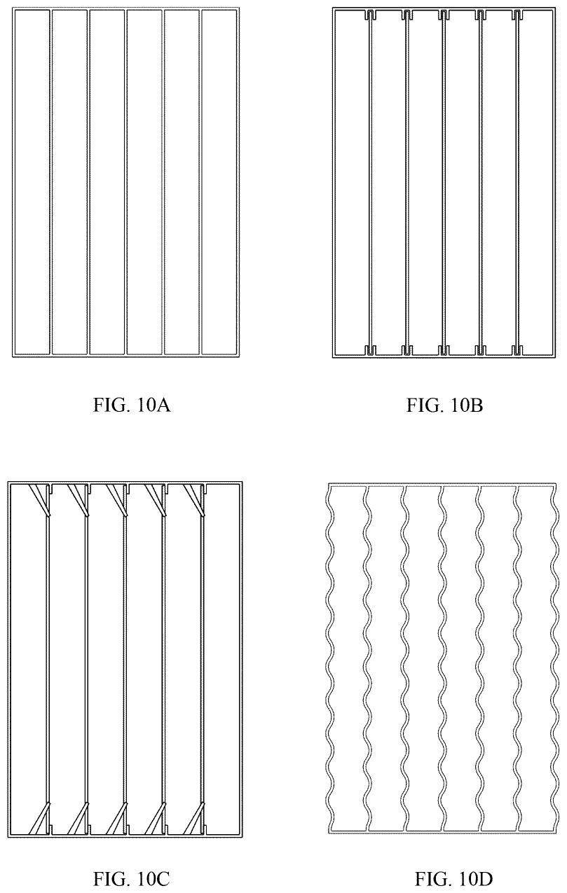

FIG. 10A-D depict exemplary configurations for recuperator heat exchange layers including alternating hot-side and cold-side layers, however other shapes and configurations are also possible. This set of exemplary flow layer configurations provides robust structures formed via extrusion processes for heat transfer functionality without leaks. FIG. 10A depicts a side view of a recuperator assembly including heat exchange layers formed via a single extrusion. FIG. 10B depicts a side view of a recuperator assembly including heat exchange walls or dividers formed for insertion into a recuperator frame. FIG. 10C depicts a side view of a recuperator assembly including heat exchange layers having insert dividers and wiper seal elements (e.g., co-extruded rubber) for improved sealing. FIG. 10d depicts a side view of a recuperator assembly including heat exchange layers having a curvilinear or serpentine wall geometry rt dividers and wiper seal elements (e.g., co-extruded rubber) for improved sealing. A single extrusion process can be used to produce continuous linear walls or plates having a uniform wall thickness and linear profile. In some implementations, co-extruded sealing elements can be incorporated into these extrusions, allowing for integration with linear heat exchange walls or plates. Additionally, a curvilinear or serpentine wall geometry can be extruded to increase the surface area along the wall or plate, significantly enhancing heat transfer efficiency by maximizing the contact area for thermal exchange.

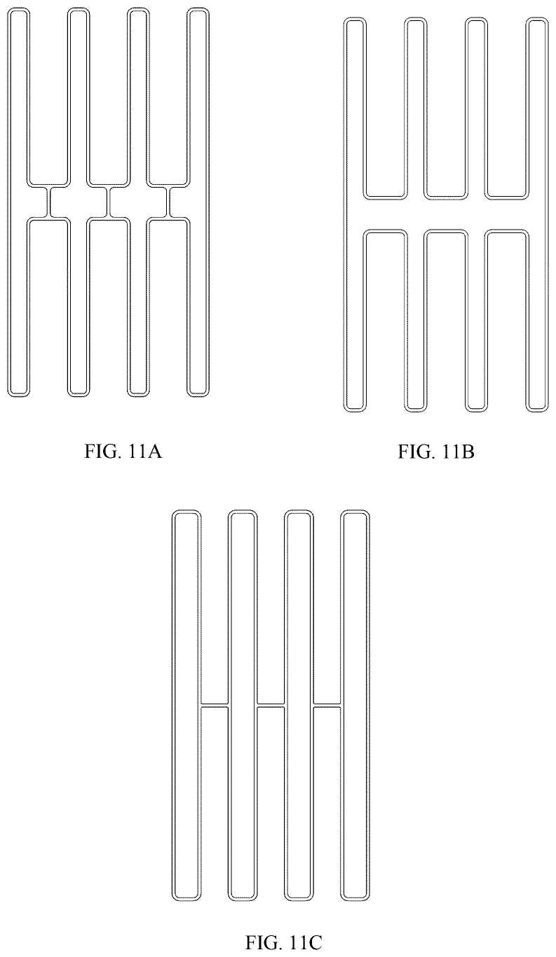

In addition to variations in the recuperator flow channel configurations, various configurations and shapes of the condenser flow channels can be architected based on the application, unit cost, and/or manufacturing approaches. FIG. 11A-C depict exemplary configurations for condenser heat exchange layers, however other shapes and configurations are also possible. This set of exemplary flow layer configurations each influences heat transfer functionality and mechanical support to the assembly. The central condenser flow channels of can comprise regeneration fluid flow while a cooling fluid can be directed through outer channels.

FIG. 11A depicts a side view of condenser heat exchange layers having parallel fused ladder sections oriented parallel to or down the length of the channels to provide a central spine to give longitudinal support. FIG. 11B depicts a side view of condenser heat exchange layers having open parallel channels providing less resistance to fluid or airflow, although may be less rigid than the fused ladder configurations. FIG. 11C depicts a side view of condenser heat exchange layers having a perpendicular fused ladder sections oriented perpendicular to heat transfer walls so as to enhance the overall strength of the assembly. The fused elements can act as a stabilizing features adding rigidity and allowing support to larger walls without compromising structural integrity.

Conventional heat exchange assemblies and water harvesting systems can require adhesive bonding or mechanical fasteners to secure air handling and/or heat exchange components to avoid air leaks which can result in higher manufacturing complexity, cost, and potential failure points. The present disclosure includes examples of mechanical interlocking features to enable joining techniques where components can be mechanically engaged with each other without adhesives, fasteners, or welding based on friction, complementary shapes, or deformation for the connection. For example, a press-fit joint or socket assembly can rely on the mechanical force and friction between two tightly fitting parts. As another example, a snap-fit joint or socket assembly can include joining features (e.g., hooks, tabs, and/or the like) to actively lock the components together. This disclosure present efficient and reliable systems and assembly methods for heat exchange assemblies and water generation devices.

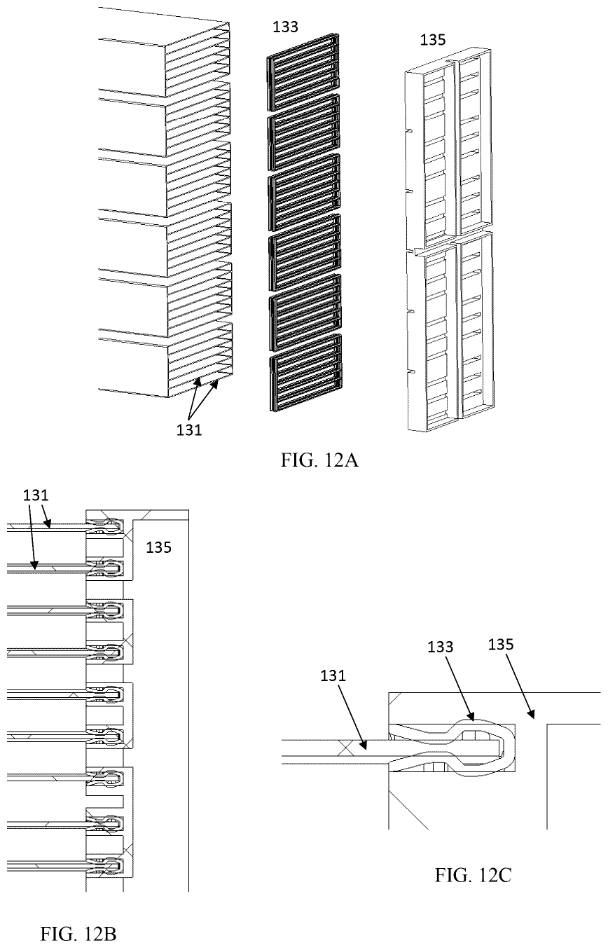

FIG. 12A depicts a side perspective view and FIG. 12B depicts a side view of a recuperator including a plurality of extruded heat exchange layers or plates 131, a sealing member 133 (e.g., gasket) and a flow directing element or plenum 135. FIG. 12C depicts a side view of mechanical interlocking seal assembly of an extruded heat exchange layer 131 aligned into plenum 135 and secured via sealing member 133 (e.g., gasket) avoiding the use of adhesives. The seal assembly depicted in FIG. 12C is one example of a mechanical interlocking socket implementation including a V-shape gasket, however other seal geometries are also possible.

Longitudinally extending heat exchange plates 131 can be extruded and aligned into a plenum 135 and secured into a socket within the plenum with sealing member (e.g., gasket) 133 providing a tight, durable seal without adhesives. The assembly comprises a plenum 135 with slots or channels that extend longitudinally to receive the edges of the heat exchange plates 131. The heat exchange plates 131 can be extruded from a thermally conductive material with an edge profile to facilitate mechanical engagement into the plenum's receiving channels. Sealing member 133 positioned within the plenum channels can provide a secure, airtight seal upon assembly without the need for adhesives or bonding agents.

The heat exchange layers or plates 131 can be provided with a continuous profile to facilitate extrusion to enable rapid manufacture of system components with precise tolerances. The mechanical interlocking mechanism(s) e.g., sealing member 133 can comprise a tapered shape such that when the heat exchange plate 131 is inserted, sealing member deflects and securely locks the plate 131 into place through a mechanical interlock with the plenum.

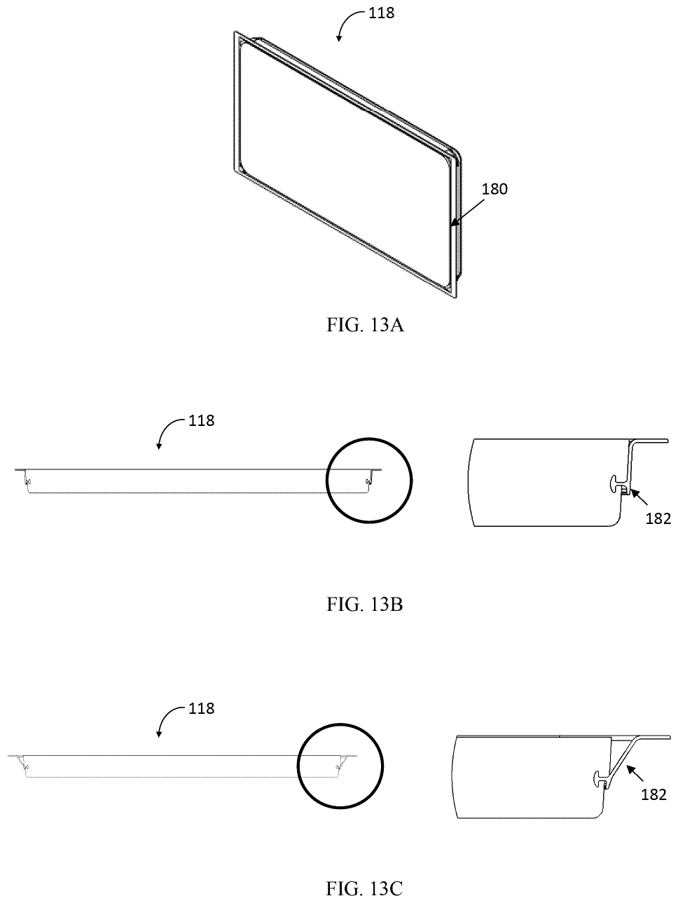

The sorption unit(s) or layer(s) (e.g., 118) can have any desirable hygroscopic material compositions and support materials or structures to establish and maintain a seal such that fluid flow is directed through the hygroscopic material or body. In one example, a hygroscopic material can be arranged within a flow distributor assembly having a dynamic seal assembly 180, for example at a perimeter such as depicted in FIG. 13A-C. FIG. 13A depicts a perspective view of a sorption unit or layer 118 comprising a dynamic seal assembly 180 having a perimeter member supporting a hygroscopic material. FIG. 13B depicts a side view of the dynamic seal of sorption unit or layer 118 in a first state and FIG. 13C depicts a side view of the dynamic seal of sorption unit or layer 118 in a second state where the hygroscopic material or body has a lower volume than the first state, for example due to having a lower water content.

The exemplary dynamic seal assembly of FIG. 13A-C can be configured to maintain a consistent airflow path through the porous hygroscopic material. Some hygroscopic materials can change in volume due to curing processes as a result of its manufacturing and/or fluctuations in water content. The example assembly comprises a perimeter member, seal or frame that surrounds the porous hygroscopic material to create a seal around its perimeter. In some implementations, the perimeter member can include a flexible polymeric sealing material (e.g., rubber or the like) that can be bonded to the assembly. In another implementation, the perimeter member can include a rigid or semi-rigid frame mechanically coupled or overmolded onto a seal material (e.g., rubber). In some implementations, the perimeter member, seal or frame can be overmolded into or onto the hygroscopic material or absorber. In some implementations, the perimeter member, seal or frame can slot into an already molded form of the hygroscopic material or absorber.

As shown in FIG. 13B and FIG. 13C, the dynamic seal assembly 180 including a frame member can comprise a protruding seal element 182 sized and shaped to securely fits into a corresponding slot or opening in the porous hygroscopic material so as to ensure a tight seal even as the material undergoes dimensional changes. Upon shrinkage of the hygroscopic material or body, the seal element 182 can transition from the state depicted in FIG. 13B to deflect inward to the state depicted in FIG. 13C. Any desirable seal can be employed to prevent fluid from bypassing the porous hygroscopic material, for example so as to direct airflow directly through it regardless of the material's expansion or contraction. A dynamic support assembly can be particularly effective where the porous hygroscopic material must maintain consistent airflow despite environmental or material-specific factors that affect its volume. As the porous material shrinks or swells, the rigid frame and protruding element(s) ensure that the seal remains intact, preventing leaks or airflow losses around the edges.

In some implementations, the water generation system can be installed with the solar thermal portion 112a along a West side and the solar electric portion 112b on an East side in the Northern hemisphere (e.g., such as depicted in FIG. 1 wherein the East direction is toward the right of longitudinal axis 102 and the West direction is toward the left of longitudinal axis 102). In some implementations, the water generation system can comprise a divider element extending upward from the front surface (e.g., optional reflective element 109 to direct solar radiation toward the front surface) between the solar thermal portion and the solar electric portion of the front surface. During the daytime, a system with a front surface light divider or reflector such as element 109 can increase solar electric generation in morning (i.e., at the expense of solar thermal generation) and increase solar thermal generation (i.e., at the expense of solar electric generation) in afternoon.

Water generation systems of the present technology can include a controller (e.g., 170) to increase the relative humidity in the regeneration fluid output from the sorption layer to drive condensation of water vapor in the condenser of the heat exchange assembly, thereby producing liquid water during the desorption mode. The controller can control one or more blowers or fans (e.g., fans 134, 136) to increase or adjust the flow rate of the process gas in the process flow path, increase or adjust the flow rate of the regeneration fluid in the regeneration flow path and/or to increase or adjust the flow rate of the cooling fluid (e.g., ambient air) in the cooling flow path. Furthermore, controller 170 can adjust the flow rate of the regeneration fluid in the closed-loop regeneration flow path during the release mode or cycle of a water generation system.

During a release operational mode, the regeneration fluid can accumulate both heat and water vapor upon flowing through the hygroscopic material in sorption layer 118 and efficiently release the accumulated water vapor upon flowing through the heat exchange assembly 130. A circulator, blower or fan (e.g., fans 134, 136) can be seated in a portion of the heat exchange assembly 130 to adjust the flow rate of the regeneration fluid during the release mode. Furthermore, one or more fans can be easily accessible for reversible replacement, for example via an access panel or lateral panel of the system. Including removable fan cartridges may be preferable to improve the serviceability of the system. In one non-limiting example, controller 170 can adjust the amount of electrical energy directed to the fan(s) based on: an environmental condition, a system power state, a system water content, a system temperature, a heat transfer effectiveness, a cooling effectiveness, a temperature difference of the system, a moisture difference of the system, or combinations thereof.

In one example, more than one cooling fan (e.g., two fans of cooling fan assembly 136) can be preferable relative to a single cooling fan because each of the plurality of cooling fans can be operated at a lower revolutions per minute (RPM) and thus have a lower power use, thereby reducing surface area of the solar electric or PV portion of the front surface.

In one illustrative example, controller 170 can adjust the amount of electrical energy directed to the fan(s) if the temperature difference between hot-side regeneration flow and cold-side regeneration flow drops below 20° C., for example the amount of electrical energy directed to the cooling fan 136 can be increased to improve cooling of the hot-side regeneration fluid. As another illustrative example, controller 170 can reduce the amount of electrical energy directed to the regeneration fan 134 i.e., reduce the regeneration flow speed if a temperature output from the thermal unit is below a predetermined threshold to increase the effectiveness of the heat exchange.

In one illustrative control approach, the controller can set the system in a loading or sorption mode wherein the process gas flows through sorption bodies 118a and 118b sequentially or ‘in series’ such as depicted in FIG. 3A. Over the course of the loading cycle, the sorption bodies 118a and 118b are loaded asymmetrically (i.e., sorption body 118b will gain a greater amount of water than sorption body 118a as a result of receiving process gas flow before sorption body 118a. The controller can redistribute water between the two absorber bodies so as to balance or ensure sorption body 118b does not become overloaded so as to weep or enter some other instability condition. Accordingly, the controller can determine a water content of the first sorption unit or body (e.g., 118b), the second sorption unit or body (e.g., 118a), or a combination thereof. The controller can then flow the process gas in a direction opposite from the initial flow direction along a series flow path (e.g., as depicted in FIG. 3A) across or through the second sorption unit or body (e.g., 118a), and then the first sorption unit or body (e.g., 118b), if the water content of the first sorption unit or body (e.g., 118b), is greater than a predetermined threshold, the water content of the second sorption unit or body (e.g., 118a) is less than a predetermined threshold, or a combination thereof.

As another example, the water generation system can maximize water production by directing the regeneration fluid to first flow along surface(s) of the PV layer (e.g., bottom and top surfaces of PV layer 114) after exiting the heat exchange assembly 130 such that the PV layer stays cooler, thus operates at high PV efficiency, and then allow the heated regeneration fluid to absorb more of the infrared (IR) backscatter heat from the sorption layer(s) (e.g., 118), top cover (e.g., glass of solar thermal portion 112a) and/or interstitial layer (e.g., glass 116). In one implementation depicted in FIG. 4A, PV layer 114 is positioned at an interstitial location such that the regeneration fluid flows along a bottom surface of PV layer 114 and then across a top surface of the PV layer 114. In another implementation depicted in FIG. 4C, PV layer 114 is positioned at a top layer (e.g., as or as part of a top cover layer) such that the regeneration fluid flows along a bottom surface of PV layer 114. In some implementations, it may be preferable to position PV layer at a top surface or cover layer which can improve cooling of the PV layer as a result of its exposure to the ambient environment. While a top or upper layer can effectively dissipate heat and thus reduce the temperature of the PV cells, thereby improving their efficiency and overall performance.

The heat exchange assemblies (e.g., 130) of the present technology can increase the relative humidity and/or the partial pressure of water vapor in the regeneration fluid to drive condensation of water vapor from the regeneration gas during the release or desorption operational mode or cycle. The heat exchange assembly 130 can reduce the temperature of at least a portion of the regeneration fluid by rejecting heat to ambient environment (e.g., in the condenser 150), another cooler portion of the regeneration fluid (e.g., in the recuperator 140) and/or another heat absorbing fluid, e.g., a refrigerant if a vapor compression cycling (VCC) unit is included. The recuperative heat exchange assembly 130 can be provided as a single unit provided as an assembly of components or be a component of a heat transfer cycle or system.

The heat exchange assembly can provide a high surface area for heat transfer to drive condensation of water vapor from the regeneration fluid, for example with minimal pressure drop upon flow across or therethrough. In one example, heat exchange assembly 130 can comprise a heat sink and/or heat transfer surfaces (e.g., heat dissipating surfaces, fins, ridges, ribs, protrusions, clamshell, passive heat sink and/or the like) to reject heat from the regeneration fluid to the ambient environment or other fluid at a lower temperature. In some embodiments, heat exchange assembly 130 can form an outer portion of the system housing so as to reject heat to the ambient environment. In other embodiments, the heat exchange assembly 130 can be located entirely within the system housing.

In addition to heat dissipating features, heat exhaust approaches and/or active or passive flow directing elements, additional components can be included to improve water production efficiency, for example, to improve the efficiency of liquid water condensation for the production of water from the regeneration flow path(s). This can be advantageous, for example when the system is in a high system water content state such that the hygroscopic materials of the system and/or the regeneration fluid are water rich (e.g., high absolute humidity, high equilibrated humidity or equilibrated water content of hygroscopic materials) to balance the efficiency of water release relative to water uptake or loading cycles. In some operational conditions or system states, water condensation can limit water production rather than water uptake or other system functions being limiting. In such states, it may be preferable to boost or improve the systems water condensation efficiency, for example by providing additional power to heat exchange assembly 130 (e.g., increase power to fan 136 for ambient air cooling).

The heat exchange assembly 130 can be provided as an air-cooled component (e.g., formed from polymeric, plastic and/or metallic materials) that can condense water from the regeneration fluid of the regeneration flow path(s). The system can power (e.g., via onboard PV layer or panel 114 and/or power from battery 190) blower(s) or fan(s) (e.g., fan 132, 134 and/or 136) to flow ambient air over and/or through the heat exchange assembly 130, thereby improving heat transfer, water condensation efficiency and therefore water production. In such implementations, ambient air cools (via heat transfer across and/or through surfaces of the heat exchange assembly 130) the hot-side regeneration fluid flow 142 through heat exchange assembly 130 in order to extract water and excess heat is exhausted to the outside environment.

Water generation systems and their component heat exchange assemblies of the present disclosure can be simple in design and easy to manufacture. In some implementations, water generation systems can operate in a hybrid or dynamic manner wherein an operational setpoint is adjusted (e.g., power distribution to fan(s) for flowing process air, fan(s) for ambient air cooling and/or regeneration fan(s) via controller 170) based on a system operational state (e.g., system power state, system water content) and/or an environmental condition (e.g., ambient relative humidity, ambient temperature) to improve water production performance. In particular, water generation systems of the present technology can increase the relative humidity (% RH) in at least a segment of the regeneration flow path to drive condensation of water vapor therefrom. Furthermore, the heat exchange assembly can increase the relative humidity in at least one segment of the regeneration flow path to drive condensation of water vapor therefrom, thereby improving liquid water production during a release operational mode or cycle.

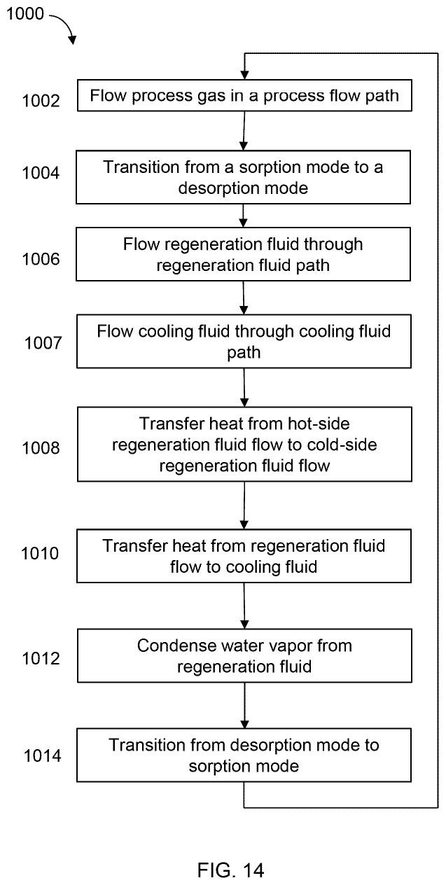

FIG. 14 illustrates method 1000 of operating a water generation system comprising a heat exchange assembly.

At operation 1002, a process gas (e.g., ambient air) flows through a hygroscopic material or sorption layer during a sorption or loading operational mode or cycle (e.g., nighttime). At operation 1002 hygroscopic material can capture water vapor from the process gas. In some embodiments, the process gas or ambient air is provided as the cooling fluid and flows through a cooling fluid path of the recuperative heat exchange assembly.

At operation 1002, a system controller (e.g., 170) can determine and/or adjust the flow rate of process gas through the water generation system, for example based on or in response to a change or threshold ambient temperature or humidity, time of day, amount of water produced, a solar insolation or irradiance, a power availability and/or the like). In one example, the controller can set or reduce the process gas flow rate or power input level (e.g., to a fan assembly) to reduce or minimize power consumption such that the length of loading mode or cycle is extended without increasing an onboard battery capacity (e.g., of onboard battery 190) and/or other power source requirement of the system which can result in a greater amount of water capture and generation for a given loading mode or cycle. In one example, the flow rate of process gas or regeneration gas through the water generation system can be between 10-250 cubic feet per minute (CFM), between 20-100 CFM, between 30-70 CFM, less than 200 CFM, and/or less than 100 CFM. Furthermore, the system components (e.g., flow through absorber, heat exchange assembly) can be designed for minimal pressure drop, for example a pressure drop through the heat exchange assembly can be between 0.05-1 inches of water (in H₂0), between 0.15-0.7 inches of water (in in H₂0), less than 1 inches of water (in in H₂0) and/or less than 0.8 inches of water (in in H₂0).

At operation 1004, the method includes transitioning from the sorption or load mode to a desorption, release or regeneration mode (e.g., daytime or morning). In one example, the method comprises monitoring ambient conditions (e.g. solar irradiance, relative humidity, temperature), system power availability, and/or actual or estimated amount of water produced or in a water generation system (e.g. loading equivalent relative humidity of the hygroscopic material) and, based on the monitored or estimated data, transitioning from a loading or sorption mode to a release or desorption mode.

Various methods comprise flowing regeneration fluid or gas along in a regeneration flow path (e.g., via actuating one or more fans) that can include the hygroscopic material at operation 1006. At operation 1006, the regeneration fluid can accumulate both heat and water vapor released from the hygroscopic material.

At operation 1006, a system controller (e.g., 170) can determine the flow rate of regeneration fluid through the water generation system, for example based on or in response to a change or threshold temperature or humidity of the regeneration fluid, time of day, amount of water produced, a solar insolation or irradiance, a power availability and/or the like). A system controller (e.g., 170) can determine if a solar insolation, system water content (e.g., absolute humidity of regeneration fluid, equilibrated water of hygroscopic materials or the like) or temperature of the regeneration fluid flowing in the regeneration flow path is above a predetermined threshold (e.g., via a sensor, via calculation or estimation based on amount of captured or produced water and/or the like), a power availability (e.g., battery SOC, PV power). In one example, system controller can reduce the flow rate of the regeneration fluid if a constant solar thermal input is received by the solar thermal unit. Reducing the regeneration fluid flow rate can increase the moisture received from the hygroscopic material resulting in greater water production.

At operation 1007, the method can comprise directing a cooling fluid (e.g., ambient air) through the system during a release or regeneration operational mode. For example, ambient air can be directed (e.g., via fan assembly 136) in a cooling flow path (e.g., 152) of the heat exchange assembly so as to supplement cooling of a hot-side regeneration fluid to drive condensation of water from the hot-side regeneration fluid flow. A system controller (e.g., 170) can determine if and/or when a cooling fluid is directed through the system, for example based on or in response to a change or threshold temperature or humidity of the regeneration fluid, time of day, amount of water produced, a solar insolation or irradiance and/or the like). Additionally, the controller can determine a cooling fluid flow rate or power input level (e.g., to fan assembly 134).

At operation 1008, the method can comprise transferring, via the recuperator, heat from a hot-side regeneration fluid flow to a cold-side regeneration fluid flow, and in some cases a cooling fluid flow (e.g., ambient air-cooling flow). For example, operation 1008 can comprise transferring heat through a heat exchange surface or plate between a regeneration fluid flow in a hot-side layer or pass of the regeneration flow path to a second regeneration fluid flow in a cold-side layer or pass of the regeneration flow path.

At operation 1010, the method can comprise directing a cooling fluid (e.g., ambient air via fan 136) through at least one layer or pass in a cooling flow path of the condenser on a side of a heat exchange plate or surface opposite the hot-side regeneration fluid flow. In some embodiments, transfer of heat from a hot-side regeneration fluid flow to a cold-side regeneration fluid flow at operation 1008 can occur concurrently or simultaneously with respect to transferring heat from the hot-side regeneration fluid flow to an ambient cooling fluid flow in the recuperator.

At operation 1008 and operation 1010, the heat exchange mechanism and/or rate can be varied based on: a user selection, data received from one or more sensors (e.g. data relating to one or more ambient conditions, data relating to water content, etc.), power availability, forecast conditions, programmatic control, an algorithm, combinations thereof, or by any other desirable bases. In on example, the method comprises continuous monitoring of ambient conditions (e.g., solar irradiance, relative humidity, temperature) and/or actual or estimated amount of water in the sorption layer and, based on the monitored or estimated data.

In some implementations, operations 1008 and/or 1010 can comprise circulating, during the desorption cycle, a refrigerant in a closed loop refrigeration circuit including a refrigerant compressor, a refrigerant condenser, a refrigerant expansion valve, and a refrigerant evaporator. In one example, operation 1008 and/or 1010 can include transferring, via the refrigerant condenser, heat from condensation of refrigerant vapor to the sorption layer. In another example, operation 1008 and/or 1010 can include transferring, via the refrigerant evaporator, heat from condensation of water vapor in the regeneration gas to the refrigerant.

At operation 1012, the method includes condensing water vapor from the regeneration gas in the regeneration flow path of the condenser to produce liquid water during the desorption cycle.

At operation 1014, the method further comprises transitioning from the desorption or regeneration operational mode to the sorption or load mode. At operation 1014, the process can be repeated or cycled. Transitioning between the desorption mode and sorption mode can be varied based on: a user selection, data received from one or more sensors (e.g. data relating to one or more ambient conditions, data relating to water content, etc.), power availability, forecast conditions, programmatic control, an algorithm, combinations thereof or by any other desirable bases. In one example, the method comprises continuous monitoring of ambient conditions (e.g., solar irradiance, relative humidity, temperature) and/or actual or estimated amount of water in the sorption layer and, based on the monitored or estimated data. In various implementations, the method can include determining if a water mass uptake by the sorption layer is greater than a predetermined mass associated with a nighttime relative humidity (e.g., average relative humidity at the panel) during a during nighttime or sorption time.

The controller can adjust or determine one or more system operational ranges and/or setpoints based on an environmental condition (e.g., solar irradiance, ambient temperature) and/or a system state (e.g., amount of onboard power available, a temperature of regeneration fluid flow), so as to efficiently condense water from the regeneration fluid. For example, controller 170 can adjust the flow rate of the regeneration fluid in the regeneration flow path (e.g., via regeneration fan 134), adjust the flow rate of the cooling fluid (e.g., via regeneration fan 136), or a combination thereof. In an embodiment, the controller can operate the system between a plurality of operational modes including: a loading mode wherein the hygroscopic material captures water vapor from a process gas (e.g., ambient air) upon flow in a process flow path; a release mode wherein the regeneration fluid accumulates heat and water vapor upon flow in the regeneration flow path, and, wherein a relative humidity in the regeneration fluid increases upon flow through the recuperative heat exchange assembly; and, a hibernation or power save mode wherein electrical power is not being consumed by the system (e.g., if available power is below a predetermined threshold, if the ambient environment is at a freezing condition).

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

Furthermore, the materials selection and controls approach can be employed for any material systems used in water generators that having a lower and/or upper operational bound or limit relating to a weeping potential, swelling potential, low vapor pressure condition, swelling, a pressure drop on water uptake, mechanical instability, chemical instability, cycling stability, or combinations thereof. Accordingly, the material design and control approaches described herein can be modified such that additional embodiments may be realized with operational, logical, chemical, and/or mechanical changes without departing from the spirit and scope of the disclosure. The claims are not intended to include, and should not be interpreted to include, means-plus- or step-plus-function limitations, unless such a limitation is explicitly recited in a given claim using the phrase(s) “means for” or “step for,” respectively. The term “about” or “substantially,” as used herein, is intended to encompass minor deviations rather define an exact value.

1. A water generation system comprising:
a housing having a front surface to collect solar radiation and a rear surface opposite the front surface, wherein the front surface comprises:
a solar thermal portion having a first area to convert solar radiation collected thereon to heat; and
a solar electric portion having a second area to convert solar radiation collected thereon to electrical energy;
a sorption layer disposed below the solar thermal portion and comprising a hygroscopic material to capture water vapor from a process gas during a sorption mode, and release water vapor to a regeneration fluid heated via the solar thermal portion during a desorption mode; and,
a heat exchange assembly disposed below the solar electric portion and comprising:
a condenser to condense water from the regeneration fluid;
a recuperator comprising a plurality of longitudinally extending heat exchange plates defining alternating flow layers to transfer heat from a first hot-side regeneration fluid flow output from the sorption layer to a second cold-side regeneration fluid flow output from the condenser.

2. The system of claim 1, wherein the housing further comprises a plurality of sidewalls extending downward from a periphery of the front surface to the rear surface to form a uniform planar configuration; and, wherein the sorption layer, the condenser and the recuperator are located within the housing.

3. The system of claim 1, wherein the solar thermal portion includes a transparent top cover layer and an interstitial layer to allow solar radiation to impinge upon the sorption layer positioned below the interstitial layer; and, wherein the solar electric portion comprises the transparent top cover layer and a photovoltaic panel positioned above the heat exchange assembly.

4. The system of claim 1, wherein the sorption layer is positioned adjacent to the heat exchange assembly within the housing.

5. The system of claim 1, wherein the first area of the solar thermal portion for solar thermal generation and the second area of the solar electric portion for solar electric generation are configured to maximize a water production rate.

6. The system of claim 5, wherein a total heat exchange surface area of the recuperator is 15-50% of the total heat exchange surface area for the heat exchange assembly.

7. The system of claim 5, wherein a total heat exchange surface area of the recuperator is 20-30% of the total heat exchange surface area for the heat exchange assembly.

8. The system of claim 5, wherein a front surface area of the system is less than or equal to 3 m² and, the first area of the solar thermal portion is 40-60% of the front surface area of the system.

9. The system of claim 1, wherein each of the plurality of longitudinally extending heat exchange plates have a thickness below 2 mm.

10. The system of claim 1, wherein the alternating flow layers have a spacing less than 12 mm.

11. The system of claim 1, wherein the first hot-side regeneration fluid flow is at least partially counter to the second cold-side regeneration fluid flow in an adjacent flow layer.

12. The system of claim 1, wherein the recuperator is a hybrid flow recuperator comprising a turn in a regeneration flow path, wherein the first hot-side regeneration fluid flows at least partially counter to the second cold-side regeneration fluid flow in a first section of a flow layer and the first hot-side regeneration fluid flow flows at least partially parallel to the second cold-side regeneration fluid flow in a second section of the flow layer.

13. The system of claim 1, wherein the condenser condenses water from the regeneration fluid via heat transfer from the regeneration fluid to a cooling fluid comprising ambient air.

14. The system of claim 13, wherein the condenser transfers heat from the regeneration fluid flowing in a closed-loop via heat transfer from the regeneration fluid to ambient air, and wherein ambient air is directed through a cooling flow path through the condenser in an open-loop via a fan.

15. The system of claim 14, wherein the fan is powered by the electrical energy generated by the solar electric portion of the system.

16. The system of claim 1, wherein the water generation system is configured to be installed with the solar thermal portion on a west side and the solar electric portion on an east side in a Northern hemisphere.

17. The system of claim 1, further comprising a controller to increase a relative humidity in the regeneration fluid output from the sorption layer to drive condensation of water vapor in the condenser, thereby producing liquid water during the desorption mode.

18. The system of claim 17, wherein the controller is configured to:
flow the process gas in a first direction along a series flow path across or through a first sorption unit of the sorption layer and then a second sorption unit of the sorption layer;
determine a water content of the first sorption unit, the second sorption unit, or a combination thereof;
flow the process gas in a second direction opposite from the first direction along a series flow path across or through the second sorption unit, and then the first sorption unit if the water content of the first sorption unit is greater than a predetermined threshold, the water content of the second sorption unit is less than a predetermined threshold, or a combination thereof.

19. A method for generating water comprising:
directing a regeneration fluid in a regeneration flow path including:
a solar thermal portion to heat the regeneration fluid;
a sorption layer comprising a hygroscopic material to capture water vapor from a process gas during a sorption mode, and release water vapor to a regeneration fluid during a desorption mode;
a heat exchange assembly comprising a recuperator and a condenser;
transferring, via the recuperator comprising a plurality of longitudinally extending heat exchange plates defining alternating flow layers, heat from a first hot-side regeneration fluid flow output from the sorption layer to a second cold-side regeneration fluid flow output from the condenser;
directing a cooling fluid through at least one pass in a cooling flow path of the condenser;
transferring, via the condenser comprising a plurality of longitudinally extending heat exchange plates defining alternating flow layers, heat from the first hot-side regeneration fluid flow to a cooling fluid; and,
condensing, via the condenser, water vapor from the regeneration fluid.

20. The method of claim 19, further comprising generating electrical energy via a PV panel to power one or more fans to flow the regeneration fluid in the regeneration flow path, the process gas in a process flow path, the cooling fluid in a cooling flow path or a combination thereof.
